(19) United States
(12) Patent Application Publication
(10) Pub. No.: US 2006/0271695 A1
(43) Pub. Date: Nov. 30, 2006

(54) System for remote secured operation, monitoring and control of security and other types of events

(75) Inventor: Yoel Lavian, Ganei Tikva (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: Electronics Line 3000 Ltd., Kiryat Arieh Industrial Zone (IL)

(21) Appl. No.: 11/433,954

(22) Filed: May 15, 2006

Related U.S. Application Data
(60) Provisional application No. 60/681,091, filed on May 16, 2005.

(51) Int. Cl. G06F 15/16

(52) U.S. Cl. 709/229

(57) ABSTRACT

A security system is disclosed for enabling remote secure operation, monitoring and management of security aspects. The system may include a gateway connected to one or more peripheral devices. The gateway may have a TCP/IP based interface, or any other suitable communication interface, for communicating with an application server enabled to be a single junction for data transfer between the gateway and end user(s), the application server providing secure communications between end user(s) and the gateway. A web server may optionally be functionally connected to the application server to enable web end user(s) to access the gateway, and there through peripheral device(s) connected to the gateway. Users may access the security system by using mobile phones, laptops, and the like, by using wired or wireless communication technologies. Peripheral device(s) may be a digital camera or IP camera and users may access the security system for displaying pictures or video images originating from these cameras. Different types of events detected by the gateway may be forwarded by the application server to users as email and/or SMS messages.

### CROSS REFERENCES

This application claims priority from U.S. Provisional Patent Application No. 60/681,091, filed May 16, 2005, entitled “INFINITE-I SERVICE PLATFORM”, which is incorporated in its entirety herein by reference.

### FIELD OF THE DISCLOSURE

The present disclosure relates generally to the field of security, home management and events driven systems. More specifically, the present disclosure relates to a system for facilitating remote control and management of security aspects, generation of events and distribution of alerts and notifications triggered by events associated, for example, with security aspects (for example intruder detection), fire detection, gas leakage detection, medical status of a person, water leakage detection and the like.

### BACKGROUND

Intrusion, fire and safety alarm systems are widely used for protecting offices, apartments and restricted areas in general. A typical security system may consist of one or more presence and/or motion detectors, such as Passive InfraRed (PIR, an electronic device that is designed to detect motion of an infrared emitting source, usually a human body) sensors, proximity switches, smoke detectors, water leakage detectors, video cameras and possibly other types of sensors/devices. Such sensors, which are installed in locations of interest (for example in a room, lobby and/or doorstep) that are to be protected, are typically connected to a local control panel that is usually installed within, or in proximity to, the protected property and connected to a suitable means for announcing or reporting an alarm event, such as to a remote central station, hopefully to elicit some response. Local control panels typically include a keypad by which a user may set (arm or enable) a security system and stop (disarm, or disable) an activated security system by typing in a corresponding code number. Once the code is typed in, the security system will either be set or will stop, depending on the previous and desired states of the security system. Depending on the type and sophistication or complexity of the security system, it may allow a user, for example, to arm and disarm the security system in respect of selected areas, for example by typing in corresponding codes. The user may instruct the security system to do other operations, such as permitting other users to operate the security system (partially or wholly), changing the system configuration and so on, depending on the flexibility of the security system used

Some security systems are dedicated to one mission (intrusion, for example), others may handle several missions, for example, fire, intrusion, and safety alarms simultaneously. Sophistication of security systems ranges from small, self-contained noisemakers, to complicated, multizoned digital systems with color-coded computer monitor outputs. Some security systems offer a user several operational modes or options, from which the user may choose one or more options by configuring the security systems manually, by keying into the keypad of the local control panel a certain code, using dual in-line package switches (DIP-switch, an electric switch that is packaged in a standard dual in-line package (DIP)), or by using jumpers (a jumper is two or more electrical connecting points that can be conveniently shorted together electrically to set up, or adjust, a printed circuit board (PCB), for example a computer's motherboard).

Depending on the security system's configuration, the system's local control panel may only activate a sound emitting device to encourage an intruder to leave the premises or the intruded vicinity as soon as he hears an alarm sound; or only activate and forward a silent alarm signal to a remote central station. A security system, however, may activate both audible and silent alarm signals. In addition, if a water leakage occurs, a suitably configured system may stop the leakage by automatically closing a corresponding water valve, and if smoke is detected a suitably configured system may activate a water sprinkler(s) to distinguish the fire.

A common security system model includes using a plain simple telephone network (PSTN) based connection, on a point-to-point basis, between a local control panel of a security system and a remote central station. According to this common model, security systems are configured, upon (in response to) the detection of an event (for example upon the detection of an intrusion), to automatically dial to a telephone number of a remote security center, and to forward to the remote central station a predetermined indication or message, often in audible form, associated with the event. Usually, in response to such indication or message, security personnel have to reach the protected property and find the cause for the alarm activation. In addition, false alarm indications are sometimes forwarded to the remote central station, in which cases time and money are spent in sending a person to the protected property for resetting the security system. PSTN lines can be cut off relatively easily without the remote central station noticing of the cut PSTN lines and, therefore, security systems, which only use PSTN lines to announce an alarm activation, become useless after cutting off the PSTN lines to which they were connected. Further, a PSTN point-to-point based security system has another drawback, which is the waiting time length it takes a local control panel to dial and reach the intended remote central station. Often, the waiting time length is in the order of a couple of minutes, which, in some cases (depending on the nature of the protected property), may be problematic if a quick response is required. In some cases, the PSTN line may be busy, which exacerbates the waiting problem.

Some security systems include a Global System for Mobile Communications (GSM) (a popular standard for mobile phones) interface in addition to a PSTN interface. A GSM interface allows security control panels to send data/messages over a GSM network, in a point-to-point manner, in a way similar to PSTN, and, in addition, a remote central station can control and configure control panels using the respective GSM interface. Further, a control panel can also use its GSM interface to send event(s) report(s) as an SMS message(s). SMS is a service available on most digital mobile phones that permits the sending of short messages (also known as text messages, messages, or more colloquially SMSes, texts or even txts) between SMS-enabled devices. For example, alarm events may be relayed, or redirected, to users' e-mail account and/or to mobile phone(s). System 100 also provides an option that includes video image transfer.

Thanks to the proliferation of the Internet, various types of data and information can be exchanged between multiple Internet users, for example fax data, by using facsimile over Internet Protocol (FoIP), voice, by using the voice over Internet Protocol (VoIP) and video, by using Internet Protocol (IP) enabled cameras (hereinafter IP cameras). However, video images originating from IP cameras are usually susceptible to interception by other Internet users and, therefore, it is not advisable to incorporate IP cameras as is into security systems. However, video images may still be used as an essential part of the security concept for various surveillance and monitoring purposes. For example, the owner of a property, or an authorized person, may remotely allow another person to enter the property, such as by remotely opening a door, only after he sees real-time video images of that person (by remotely activating a video camera). Therefore, it would have been beneficial to find a way to incorporate video cameras into security systems and transmit on demand (whenever required or desired) real-time video images through a secured channel, on a point-to-point basis.

The advent of the Internet, the rise of home networking and the development of remote controllers have introduced new opportunities to gain access to local control panels of security systems, and also to (smart and non-smart) home appliances, while away from home. For example, users may remotely monitor their property and control, including reconfiguring, various electronic devices and components of their security system, home appliances, gadgets, lights and so on, by using Internet access, for example. Exemplary home appliances are television sets, stereo audio systems, refrigerators, microwave oven, water boilers, and the like.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

The term “gateway” is used hereinafter to denote an apparatus that has capabilities of (or has the capability to function as) a control panel on one hand, and, on the other hand, it also has capabilities of (or has the capability to function as) a network gateway, to enable exchange of data/messages between the control panel part of the gateway to a remote central station in the way disclosed hereinafter. Put otherwise, the gateway may be thought of as a network gateway having the capabilities of a control panel, or as a control panel having the capabilities of a gateway.

There is provided, in accordance with various embodiments, apparatuses, systems, and methods for remote secure management of applications. According to some embodiments of the present disclosure the system may include an application server enabled to be a single junction for data transfer between a gateway and end user(s). The gateway may be functionally coupled to one or more peripheral devices, each of which may be configured, controlled or monitored by the gateway. The one or more peripheral devices may forward data or signal(s) to the gateway responsive to, or in association with, respective event(s). End user(s) may generally relate to one or more end user(s), third party service provider(s), third party service(s)/application(s), system owner(s), system manager(s) and emergency service(s)/application(s). Peripheral device(s) may be coupled to the gateway wirelessly or by cable(s). Data, message(s) or event(s) report(s) may be transmitted from the application server to end user(s), for example as corresponding SMS(s) or e-mail(s).

According to some embodiments the gateway may be configured or programmed by, or remotely through, the application server, through use of a TCP/IP part of a TCP/IP and PSTN module. The system may further include a proxy server adapted to interface between the application server and third party application(s), which may be legacy system(s) or any other monitoring application(s). The system may include a web server coupled to the application server and adapted to allow an authorized end user(s) to monitor and/or control and/or configure the gateway. The communication between the gateway and the application server may be encrypted. Signal(s) forward to the gateway from peripheral device(s) may represent digital video stream(s) or picture(s), and the application server may securely forward to authorized end user(s) selected digital video stream(s) and pictures originating from one or more cameras.

The system may further include a router functionally coupled to the gateway and to camera(s) for facilitating real-time transfer of picture(s) and video stream(s) to an authorized web user. The router may be adapted to receive command(s) from the application server and/or from the gateway to enable real-time transfer of picture(s) and video stream(s) from camera(s) to an authorized web user through the router and through the application server,

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustarted in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 is a schematic block diagram of an applications management system, according to some embodiments of the present disclosure;

FIG. 1a is a basic system used for explaining how a user views video streams or pictures according to some embodiments of the present disclosure;

FIG. 2 is a schematic block diagram of an implementation of an applications management system, according to some embodiments of the present disclosure;

FIG. 3 is a is a schematic block diagram of an implementation of an applications management system including third party applications, according to some embodiments of the present disclosure;

FIG. 4 is a schematic block diagram of an implementation of an applications management system with a plurality of proxy servers, according to some embodiments of the present disclosure;

FIG. 5 is a schematic block diagram of an additional implementation of an applications management system, according to some embodiments of the present disclosure;

FIG. 6 is a schematic block diagram of a different configuration of an applications management system, according to some embodiments of the present disclosure;

FIGS. 7 through 14 depict exemplary monitoring and configuration portlets in accordance with the present disclosure; and

FIGS. 15 through 20 depict exemplary portlets for implementing and using video features in accordance with the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate like elements.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, “deciding”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present disclosure may include an apparatus for performing the operations described herein. This apparatus may be specially constructed for the desired purposes, or it may comprise a general-purpose computer selectively activated or reconfigured by a computer program stored in the computer.

Network adapters may also be coupled to the system to enable the data processing system to become coupled to other data processing systems or remote printers or storage devices, or the like, through intervening private, public or other networks. Modems, cable modem and Ethernet cards are just a few of the currently available types of available network adapters.

The processes and displays presented herein are not inherently related to any particular computer or other apparatus. Various general-purpose systems may be used with programs in accordance with the teachings herein, or it may prove convenient to construct a more specialized apparatus to perform the desired method(s) or develop the desired system(s). The desired structure(s) for a variety of these systems will appear from the description below. In addition, embodiments of the present disclosure are not described with reference to any particular programming language. It will be appreciated that a variety of programming languages may be used to implement the teachings of the disclosures as described herein.

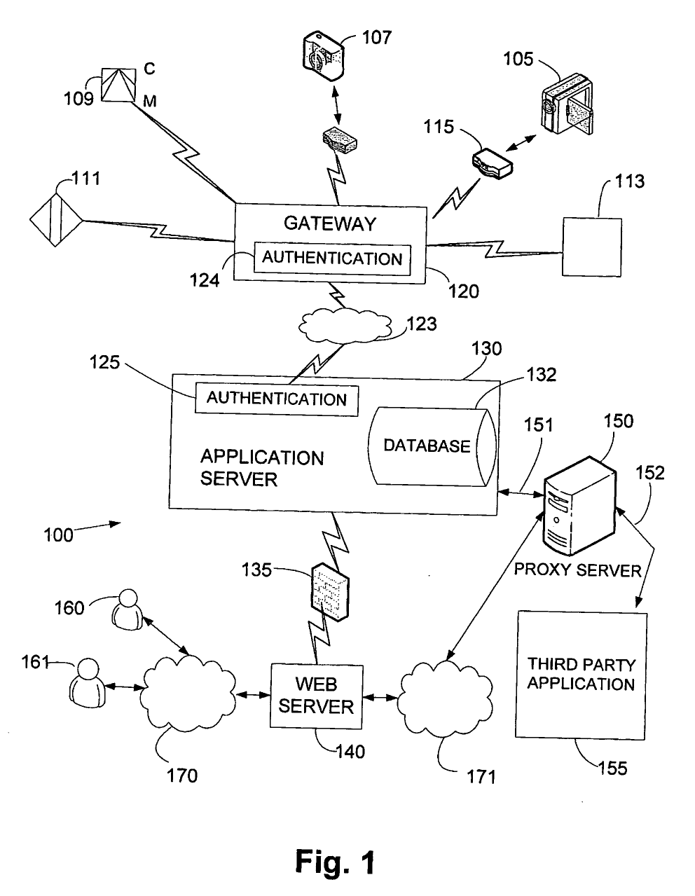

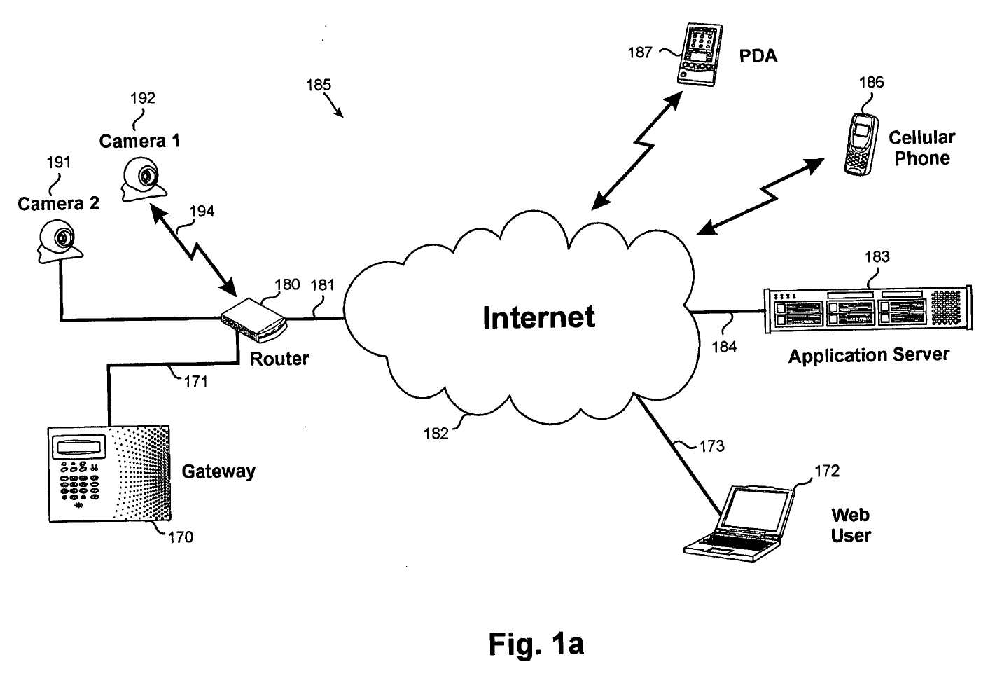

Referring now to FIG. 1, it shows, by way of example, a general layout and functionality of a security management system (generally shown at 100) according to some embodiments. Security management system 100 may include one or more data/information input and/or output devices, all of which are collectively referred to hereinafter as “peripheral devices”. Peripheral devices may include, for example, one or more video cameras such as video camera 105, one or more digital cameras such as digital (IP-enabled, or non-IP) camera 107, one or more motion detectors such as motion detector or PIR detector 109, one or more proximity sensors such as proximity sensor 111, and other types of peripheral devices such as optical sensors or other suitable sensors or detectors, sirens and home automation appliances 113, and so on. Peripheral devices may be wired or wireless devices, and they may have TCP/IP protocol based interface, though this is not necessary, as other standard or proprietary suitable interfaces may be used in its instead. Video camera 105 and digital camera 107 may be wired or wireless IP camera. Video camera 105 may be supplied with or without motion sensors and audio supports (built-in microphones). Other types of peripheral devices may be used for monitoring of and/or measuring a variety of parameters, for example PIR sensors, smoke sensors, gas detectors, temperature sensors, magnetic switches (contact sensors), gas valve detectors, glass breaking sensors, flood detection sensors, health care devices, vibration sensors and other suitable sensors. Application server 130 may be adapted to be a single junction for secure transfer or communication of data between gateway 120 and Web server 140 and/or proxy server 150. For example, application server 130 may restrict access to gateway 120 to commands channeled through application server 130 only, thereby preventing direct access from Web server 140 and/or proxy server 150 to gateway 120.

Other types of peripheral devices may include input devices such as water measurement instruments, Automatic Meter Reading (AMR) devices, electricity measurement apparatus, gas measurement instruments or other suitable sensor devices. In a further example a medical monitoring system may include input devices such as heart pulse monitors, blood pressure monitors, body temperature monitors, or other suitable medical sensor devices. In an additional example a home or office applications management system may include applications such as air-conditioner units, microwave ovens, refrigerators, computers, lights, washing machines, hot tubs, dishwasher appliances, or other suitable applications to be remotely managed. Other systems with other input devices may be used.

Security management system 100 may include also a gateway such as GATEWAY 120, which is intended to function as a (smart) local control panel. GATEWAY 120 (for example) may run an authentication application (shown as AUTHENTICATION 124) in addition to other applications associated with the communication protocol(s) which are used by GATEWAY 120 to send and receive data to/from APPLICATION SERVER 130 (whether wirelessly or not). GATEWAY 120 may reside within, or nearby, the protected or monitored property or area. Each one of exemplary peripheral devices 105, 107, 109, 111 and 113 may communicate with GATEWAY 120 via an intermediate interface. For example, video camera 105 is symbolically shown communicating with GATEWAY 120 via interface 115, which may be a router, for example, whereas motion detector 109 (for example) is shown directly coupled to GATEWAY 120. Interface 115 may be connected, or otherwise functionally coupled, to a broadband or narrowband data access port (not shown), which may be wired and/or wireless. GATEWAY 120 may be, for example, controlled locally (by an end user) via wired or wireless keypad, smart key (key fob, for example), computer terminal, mobile computing device or other suitable device. GATEWAY 120 may have a TCP/IP based interface, and it may be connected to a data access port, for example a broadband, narrowband or other suitable port, the connection being, for example, via a router or other suitable network device. An authorized user may control or monitor the status and configure GATEWAY 120 (the local control panel) by using a web browser, cellular device, personal digital assistant (PDA) and/or other custom web-based applications. In particular, GATEWAY 120 may be configured or programmed by (or remotely through) APPLICATION SERVER 130 by using the TCP/IP based interface.

GATEWAY 120 may also be coupled, connected or otherwise associated with an APPLICATION SERVER 130. GATEWAY 120 may communicate with APPLICATION SERVER 130 directly over the Internet or other communications network (generally shown as data network 123). GATEWAY 120 may communicate with APPLICATION SERVER 130 over secure TCP/IP connection through a cable modem, ADSL, GPRS or via other TCP/IP based interface(s). GATEWAY 120 may be constructed, configured, or otherwise be adapted, to be modular, for facilitating future integration of additional peripheral devices that may be known today or devised in the future. GATEWAY 120 may include a data authentication module (shown at 124) to enable secure communication of data to, and from, APPLICATION SERVER 130, using for example data encryption, data authentication and/or other suitable data security means.

APPLICATION SERVER 130 may run an authentication application (AUTHENTICATIONA 125) in addition to other applications associated with the communication protocol(s) used by APPLICATION SERVER 130 to send and receive data, wirelessly or by wired lines. APPLICATION SERVER 130 may be accessed by clients (users and service providers) of security management system 100, and APPLICATION SERVER 130 may include a database (shown as DATABASE 132) for storing and managing data relating to these clients, gateways (such as GATEWAY 120) and service providers, as well as events and events-related scenarios associated with the gateways and users. DATABASE 132 may also include data relating to authentication and authorization levels of users and service providers, and to reports and logbook. DATABASE 132 may also include data relating to every local control panel (gateways such as GATEWAY 120) and to peripheral devices. DATABASE 132 may reside within APPLICATION SERVER 130, or DATABASE 132 may reside externally and be accessible by APPLICATION SERVER 130.

By “event” is generally meant herein any occurrence causing the/any activation (incidental, intentional, programmed, scheduled or predetermined) of one or more peripheral devices connected to a gateway such as GATEWAY 120. Depending on the configuration of security system 100, GATEWAY 120 (for example) may or may not forward to an application server (such as APPLICATION SERVER 130) a message relating to the event. Events may be triggered by one or more peripheral devices or detectors. For example, a relatively simple event may be triggered by a detected broken window. A more complex event may be triggered, for example, by a combination of detected broken window and a video image of a person authorized to enter the premises. By “service provider” is generally meant herein a firm, company or authority who provides a service(s) to a user(s)/client(s) according to, or in response to, a specific event or specific type of events. For example, upon detection of an intruder the remote control center (the application server) may automatically call the police. According to another example, upon detection of flood, the remote central station (APPLICATION SERVER 130) may call a fire brigade, and so on. AUTHENTICATION 125 of APPLICATION SERVER 130 verifies that data transactions/exchange can occur only between APPLICATION SERVER 130 and GATEWAY 120, over communication connection 123 (for example), and that other, unauthorized, entities (end users) cannot monitor, interfere with the, or intercept, data exchanged between GATEWAY 120 and APPLICATION SERVER 130.

According to some embodiments GATEWAY 120 may be configured, programmed, or otherwise be adapted, such that GATEWAY 120 can be accessed only by, and communicate only with, APPLICATION SERVER 130. Put otherwise, end users such as users 160 and 161 and third party applications such as third party application 155 can communicate with GATEWAY 120 only if authorized to do so, and only via APPLICATION SERVER 130, and GATEWAY 120 cannot, or is not permitted to, forward data to destinations other than APPLICATION SERVER 130. This feature ensures the integrity of the data flow exchanged between GATEWAY 120 and APPLICATION SERVER 130. In addition, the point-to-point like communication between GATEWAY 120 and APPLICATION SERVER 130 may be performed using encryption method(s), for example Secure Sockets Layer (SSL, a cryptographic protocol which provides secure communication on the Internet), or IP security (Ipsec or IPSEC, a standard for securing Internet Protocol (IP) communications by encrypting and/or authenticating all IP packets.) which increases the security level involved in data flow exchanged over a packet switched data network such as data network 123.

Depending on the application and on the type of event(s) encountered or detected by GATEWAY 120 and acknowledged/registered by/at APPLICATION SERVER 130, APPLICATION SERVER 130 may be configured or programmed to send message(s) to a legacy system such as THIRD PARTY APPLICATION 155 and/or to any other monitoring application(s). Being an exemplary legacy system, THIRD PARTY APPLICATION 155 may need a proxy server, such as PROXY SERVER 150, to allow APPLICATION SERVER 130 and THIRD PARTY APPLICATION 155 to exchange data in the corresponding format(s) or standard. Put otherwise, PROXY SERVER 150 may use a first data format and/or communication standard to exchange data (shown at 151) with APPLICATION SERVER 130 data, and a second data format and/or communication standard to exchange data (shown at 152) with THIRD PARTY APPLICATION 155. This way, third party applications (THIRD PARTY APPLICATION 155, for example), which may run by service providers, may be seamlessly integrated into system 100. PROXY SERVER 150 can be physically located in the service provider site or, if required, the functionality of PROXY SERVER 150 may be performed by APPLICATION SERVER 130, with a standard IP-to-Serial conversion module connected between APPLICATION SERVER 130 and the server running the service provider's application.

APPLICATION SERVER 130 may support many gateways such as GATEWAY 120, many end users such as users 160 and 161 and many service providers such as THIRD PARTY APPLICATION 155. Legacy service providers who want to use at least some of the benefits offered by APPLICATION SERVER 130 (web-based system, quicker event response time, high capacity, event reports, higher reliability, pictures and real-time video images, and so on) and gateways such as GATEWAY 120 do not need to change their legacy systems. What they need to do is to use a proxy server (such as PROXY SERVER 150) as an interface to APPLICATION SERVER 130.

WEB SERVER 140 may be functionally connected to end user 160 and/or to end user 161, and also to APPLICATION SERVER 130, optionally via firewall 135 or other suitable secure access means. WEB SERVER 140 may enable end users 160 and 161 to securely access APPLICATION SERVER 130, thereby remotely controlling operation of GATEWAY 120 and devices 105-113 functionally connected to GATEWAY 120.

According to some embodiments, by way of example, PROXY SERVER 150 may be provided to communicate between APPLICATION SERVER 130 and third party applications 155, for monitoring stations, fire services, medical services and so on. For example, if a monitoring station operates a legacy system for security monitoring, medical condition monitoring and so on, the legacy system may be functionally connected to PROXY SERVER 150 to enable translation (mediation) of events related data, which were originally sent from GATEWAY 120 to APPLICATION SERVER 130, before that data, or data associated with that data, is from APPLICATION SERVER 130 to the legacy system. According to some embodiments PROXY SERVER 150 may be part of APPLICATION SERVER 130. According some embodiments PROXY SERVER 150 may enable protocol transformation between APPLICATION SERVER 130 and a legacy Applications Management System located in a monitoring station or similar facility. In other embodiments PROXY SERVER 150 may enable monitoring of the communication links between APPLICATION SERVER 130 and a legacy Applications Management System or legacy monitoring station or system, to be able to alert the Applications Management System when a disruption of communication occurs. Of course, other architectures or schemes may be used.

GATEWAY 120 may be connected, for example, by a cable or wirelessly, to one or more of peripheral devices 105 through 113, to receive therefrom signals and/or data relating to a current security state, or event(s) in general. Put otherwise, peripheral device(s) may forward data and/or signal(s) to GATEWAY 120 responsive to, or in association with, respective event(s). In cases where a reconfigurable, or controllable, peripheral device is connected to GATEWAY 120, GATEWAY 120 may be configured, programmed, or otherwise adapted, to transmit commands to control the operation of the configurable, or controllable, peripheral device. For example, video camera 105 may be reconfigurable, or controllable, so as to allow GATEWAY 120 to operate, shut down and change modes of operation and so on, of video camera 105, for example.

APPLICATION SERVER 130 may include a DATABASE 132 that may include, for example, data relating to various parameters of the peripheral devices coupled to GATEWAY 120, GATEWAY 120, end users 160, information related to applications connected to PROXY SERVER 150 and/or other suitable data DATABASE 132 may be a separate database server and/or a database server that is part of (incorporated or embedded into, or affiliated with) APPLICATION SERVER 130. APPLICATION SERVER 130 may enable receipt of communications from GATEWAY 120, for example, by using Internet based communications, wireless communications or other suitable types of communications. APPLICATION SERVER 130 may include a data authentication module 125 to enable secure communication of data to GATEWAY 120, using for example data encryption, data authentication and/or other suitable data security means. APPLICATION SERVER 130 may be coupled to a firewall 135, Virtual Private Network (VPN) or other suitable access security means, to prevent unauthorized access to APPLICATION SERVER 130 or, via APPLICATION SERVER 130, to GATEWAY 120.

The bi-directional communication between GATEWAY 120 and APPLICATION SERVER 130, which may be implemented over data network 123 or by using any other suitable method (for example by using the General Packet Radio Service—GPRS, a mobile data service available to users of GSM (Global System for Mobile Communications) mobile phones) may be thought of as a virtual private network (VPN) that excludes substantially all non-authorized users from accessing data or signals within security system 100. A significant benefit of the VPN-like communication is that it enables, among other things, secure communications of pictures from one or more digital cameras such as digital camera 107, and of video images from one or more video cameras such as video camera 105. Once pictures and video images are forwarded to APPLICATION SERVER 130, they may be stored, for example in DATABASE 132, and accessed only by end users authenticated and authorized by AUTHENTICATION 125. Secure handling (transmission, storage, access and so on) of pictures and video images is a very important feature because, often, a security event (and any other type of event for that matter) may be better evaluated in the visual dimension. Secured handling of pictures and video images may also allow an end user (end user 160, for example) to gain an access to APPLICATION SERVER 130 and, after being authenticated by AUTHENTICATION 125, to get from APPLICATION SERVER 130, and to display on its own PC display screen, pictures and/or video images of the area or property covered by the corresponding camera(s) and/or video camera(s).

A system architecture that combines an application server such as APPLICATION SERVER 130 and a gateway such as GATEWAY 120 to which peripheral devices are coupled, creates a web-based security platform (security system 100) that is very efficient and quick to respond to numerous types of events and scenarios. In addition, security system 100 is customizable, scalable and very flexible, and it may be very easily updated and modified according to needs, as will be demonstrated hereinafter by some, not exhaustive, examples.

Features of a Security System Enabled Using a System Such as System 100:

1. Event Reporting and Notification—Events originating from one or more local control units (gateways such as GATEWAY 120) may be reported, preferably over TCP/IP communication path, to APPLICATION SERVER 130. Based on the event type and the configuration of APPLICATION SERVER 130, the APPLICATION SERVER 130 may redirect the event, or data associated with it, to a proxy server such as PROXY SERVER 150, which may be located at the desired service provider's site. For example, burglary type events may be redirected to a security service providing company; fire events may be redirected to a fire service providing company; Automatic Electricity Meter Reading (AMR) data may be redirected to the electricity service provider, and so on. APPLICATION SERVER 130 may be configured (such as by an administrator) to send all events, or data relating to, or associated with, the events to a single service provider, or to multiple service providers, according to the type of event. A security event, for example, may be reported to the police and/or to one or more persons (for example to a the property owner). According to another example, detection of flood (by flood detectors) may result in the transmission of a notice to the owner of the property and/or to his neighbor and/or to a fire brigade station, and so on. Based on configuration and/or preset parameters of APPLICATION SERVER 130, APPLICATION SERVER 130 may send event-related message(s) to users, service providers, system administrators and/or to maintenance personnel, by using, for example, e-mail(s) and/or SMS message(s).

2. Communication lines supervision—As opposed to traditional systems where supervision of communication lines between a traditional local control unit and a service provider is done by periodically forwarding test signals between the two parties at a regular interval (hourly/daily/monthly), the system disclosed by the present disclosure (shown generally as 100) provides constant supervision over the local control panels by the application server (APPLICATION SERVER 130, for example). APPLICATION SERVER 130 (for example) may monitor (or otherwise check), periodically or continuously, the communication connection between the APPLICATION SERVER 130 and each one of the registered gateways, each of which may function in the way described in connection with GATEWAY 120. If a gateway (such as gateway 130) is disconnected (such as by cutting the connection line wires) from APPLICATION SERVER 130, APPLICATION SERVER 130 will quickly (typically within a few seconds) notice that fact and immediately notify the off-line condition to the relevant parties (for example to the system administrator, service provider, end user, and so on), such as by sending to them a corresponding audio and/or visual message.

As part of the present disclosure GATEWAY 120 and APPLICATION SERVER 130 may exchange data for determining whether IP communication path 123 is intact. According to some embodiments GATEWAY 120 may forward test signals (“I am alive” messages) to APPLICATION SERVER 130 over IP communication path 123 according to a predetermined test policy, and wait to receive from APPLICATION SERVER 130 an acknowledgement signal in response. For example, GATEWAY 120 may forward a test signal to APPLICATION SERVER 130 once every several seconds (for example once every 20 seconds). An acknowledgement message may be returned to GATEWAY 120 from APPLICATION SERVER 130 in response to each test signal received at APPLICATION SERVER 130. Since APPLICATION SERVER 130 expects to receive from GATEWAY 120 test signals according to a test policy or scheme known to it and GATEWAY 120 expects to receive from APPLICATION SERVER 130 respective acknowledgement messages, both GATEWAY 120 and APPLICATION SERVER 130 can determine whether the IP communication path there between (shown at 123) is intact.

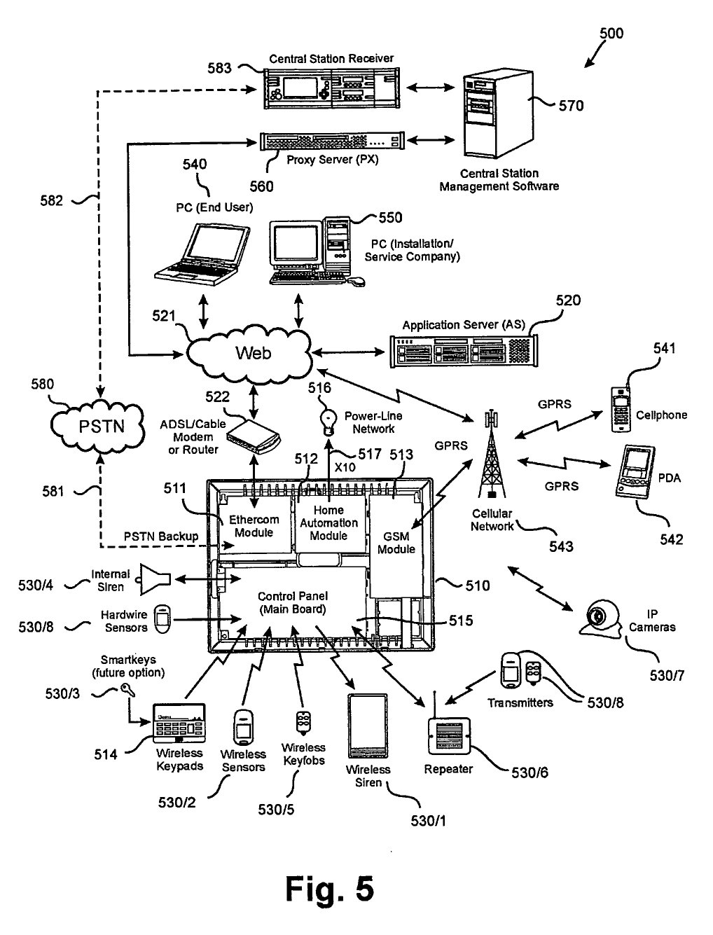

If GATEWAY 120 fails to timely receive an acknowledgement message from APPLICATION SERVER 130 during a prescribed time length, GATEWAY 120 assumes that IP communication path 123 is problematic and, therefore, GATEWAY 120 switches over from IP communication path 123 to PSTN communication as a backup, as is shown, for example, in FIG. 5, where Gateway 510 is shown coupled to PSTN network 580. Once communication is switched to PSTN-based communication, GATEWAY 120 may send (over the PSTN network) messages directly to the designated third party application(s), rather than sending them to APPLICATION SERVER 130 as before (when IP communication path 123 was still intact). For example, Gateway 510 is shown in FIG. 5 exchanging data (shown at 581 and 582) with a third party (Central Station Receiver 583). If APPLICATION SERVER 130 fails to timely receive a test signal from GATEWAY 120, APPLICATION SERVER 130 assumes that IP communication path 123 is problematic and, therefore, APPLICATION SERVER 130 may send a communication-malfunctioning message to one or more users, according to a users list stored in the APPLICATION SERVER 130 or in a memory device associated with APPLICATION SERVER 130. According to some embodiment the gateway may include a GSM module and the backup communication path may be implemented using GSM, rather than PSTN, as is described more fully in connection with FIG. 5.

According to some embodiments of the present disclosure GATEWAY 120 may forward more frequently test signals (I am alive messages) to APPLICATION SERVER 130 when security system 100 is in active mode of operation (the system is armed) then it does when security system 100 is in inactive mode of operation (the system is disarmed). For example, GATEWAY 120 may send to APPLICATION SERVER 130 I am alive messages once every three seconds when it is in active mode of operation, and once per 30 seconds when it is in inactive mode of operation.

3. Secure Data Transactions—All data transactions via the Web (123, 170 and 171) between a local control unit (such as GATEWAY 120), application server (such as APPLICATION SERVER 130), proxy servers (such as PROXY SERVER 150) and end users (such as users 160 and 161) are made substantially fully secured by using: (1) User Name(s) and Password(s), and (2) SSL Certification and Authentication, and (3) SSL Data Transactions.

4. Web User Remote Access via PC/PDA/Mobile Phone—APPLICATION SERVER 130 may serve as a web site to enable user(s), such as users 160 and/or 161, to communicate with GATEWAY 120 by using a standard tool such as a web browser, PDA, mobile phone or by using other web-enabled, or web-driven devices. According to some embodiments of the present disclosure a user wishing to access a local control unit (gateway) is required to log into the application server with which the local control unit securely communicates.

After logging in, transactions may be carried on between the user (for example user 161), by using a suitable user's application, and GATEWAY 120, while APPLICATION SERVER 130 intermediating between them. This feature ensures high system security. Once the user has logged into APPLICATION SERVER 130, the Web application may offer to him various features such as arming and disarming of GATEWAY 120, home automation control and system configuration. Already logged in users may also upload a log file and access selected data items within their system's log. In addition, the security system disclosed by the present disclosure includes use of video features as is described in more details hereinafter, which may be based on wired and/or wireless standard digital and/or IP cameras. For functionally incorporating a digital or an IP camera into a security system such as exemplary security system 100 of FIG. 1, the digital, or IP, camera has to be configured or programmed accordingly.

Video Features:

5. Cameras Control and Real-Time Video Monitoring—Users, or clients, of a security system such as security system 100 of FIG. 1 may remotely control selected cameras. By “control” is meant switching a selected camera on and off, changing the camera's field of view (“FOV”), zooming-in and zooming-out, rotating the camera to wanted directions (within the physical limits of the camera), and so on. Users may also obtain, in real-time, secured pictures and video images.

As was explained before, confidentiality of video images (and other types of data) is maintained substantially at all times because the video and digital cameras connected to GATEWAY 120 are accessible only via (and controllable only by) APPLICATION SERVER 130, which may import pictures or video images from specific cameras only after a user or client requesting selected pictures or video images successfully logs into the application server, and, in addition, enters a password that is unique to a specific camera of interest. That is, if a user desires to obtain for inspection selected video images from two video cameras (for example) such as video camera 105, the user will need to enter, or use, two different passwords, one password for each camera. To obtain even a better security level the user (user 160, for example) may use SSL certificate. Video stream and pictures may be viewed by one or more end users in several ways, in a “pictures/video on demand” manner, as is more fully described in connection with FIG. 1a, for example.

Referring now to FIG. 1a, a system (generally shown at 185) for demonstrating several viewing control mechanisms, by which user(s) may view a video stream and/or pictures, is schematically illustrated. Gateway 170 is coupled (shown at 171) to Router 180, which is coupled (shown at 181) to Internet 182. Web User 172 and Application Server 183 are coupled (shown at 173 and 184, respectively) to Internet 182. Cameras 1 and 2 (shown at 191 and 192, respectively) are coupled (shown at 193 and 194) to Router 180. PDA 187 and Cellular Phone 186 are IP-enabled devices. In general, Router 180 may be configured or programmed (or otherwise adapted) to receive instruction(s), order(s) or command(s) from Application Server 183 to enable real-time transfer of picture(s) and/or video stream(s) from Camera 191 and/or Camera 192 to an authorized web user (for example Web User 172), through Router 180 and through Application Server 183.

According to some embodiments of the present disclosure, there are several viewing control mechanisms by which video streams and pictures can be relayed and displayed to end user(s). According to a first exemplary viewing control mechanism, viewing video streams and pictures may involve controlling Router 180 directly by Application Server 183 (over Internet 182). According to a second exemplary viewing control mechanism, viewing video streams and pictures may involve controlling Router 180 by Application Server 183 (over Internet 182) indirectly, through Gateway 170. A user (for example Web User 172) may have a direct access to Cameras 191 and 192, through Router 180. Alternatively or additionally, Application Server 183 may instruct Cameras 191 and 192 to push (to Application Server 183) requested/selected video streams and/or pictures, and Web User 172 may access Application Server 183 and selectively retrieve there from, in a pictures/video on demand manner, video streams and pictures in which he is interested.

According to a first exemplary viewing control mechanism a web user, for example Web User 172, may access application server 183 and, after application server 183 successfully authenticates him, Web User 172 may select a camera(s) (for example Camera 191) for viewing a video stream or pictures of his choice. Responsive to the selection of a camera(s) by Web User 172, Application server 183 may instruct Router 180 to grant Web User 172 a direct access to the requested camera(s). By “direct access to the requested camera(s)” is meant allowing a user (Web User 172, for example) an access to camera(s) embedded web server (IP-enabled camera(s)) in order to allow the user to retrieve video images and/or pictures as originally generated by the accessed camera(s). Upon, or responsive to, the termination of the video session by Web User 172, application server 183 may instruct Router 180 to block access to the currently accessed camera (Camera 191 in this example).

According to a second exemplary viewing control mechanism a web user, for example Web User 172, may access application server 183 and, after application server 183 successfully authenticates him, Web User 172 may select a camera(s) (for example Camera 192) for viewing a video stream or pictures of his choice. Responsive to the selection of camera(s) by Web User 172, Application server 183 may instruct Gateway 170 to instruct Router 180 to grant Web User 172 an access to the requested camera(s) embedded web server. Upon, or responsive to, the termination of the video viewing session by Web User 172, application server 183 may instruct Gateway 170 to instruct Router 180 to block access to the currently accessed camera, or cameras (Camera 192 in this example). Regardless of the two viewing control mechanisms described earlier, after Router 180 is instructed (either by application server 183 or by Gateway 171) to grant access to Web User 172, Web User 172 may access the camera embedded web server in order to selectively retrieve camera video images and/or pictures.

According to some other embodiments of the present disclosure Router 180 does not block access to the camera(s), and instead of a web user (for example web user 172) accessing the camera(s) embedded web server, the camera(s) may push the video image(s) stream(s) or picture(s) (upon request) to predefined destination(s), for example to Application server 183. That is, as Web User 172 accesses application server 183 and selects a camera (for example Camera 191), application server 183 may instruct Gateway 170 to activate the selected camera (Camera 191 in this example) and to cause it to send (push) (over Internet 182) a video stream(s) to application server 183. Once application server 183 starts receiving a video stream from the selected camera, application server 183 may redirect the video stream received by it only to Web User 172, or to Web User 172 and other web users (substantially at the same time, concurrently or after some delay), and/or to store the video stream(s) at a storage medium for accessing this stored video at a later stage. According to some other embodiments, application server 183 may convert received (or stored) video streams into different data/signal formats and send them (in a suitable format) to different appliances, for example to PDA 187 or cellular phone 186, for displaying the video streams to a user.

The Web site on APPLICATION SERVER 130 may be configured with information concerning the IP cameras installed on-site. When the user selects or specifies to APPLICATION SERVER 130 a desired camera(s), APPLICATION SERVER 130 may communicate, or negotiate capabilities, with the specified camera(s), via GATEWAY 120, after which a video channel may open between the specified camera(s), GATEWAY 120 and APPLICATION SERVER 130. Then, the user may see pictures, or video images (depending on the type of camera), by using standard tools such as a web browser, or by using a customized application.

The user may use a readily available mobile phone or PDA that is designed, or adapted, to import pictures and/or video images from a packet switched network such as the Internet. In such a case, pictures or video stream may be forwarded from the corresponding camera to the APPLICATION SERVER 130, and converted in APPLICATION SERVER 130 into format suitable for the mobile phone or PDA format. Then, APPLICATION SERVER 130 may forward the pictures, or video stream, to the user's device (mobile telephone or PDA, for example), in a suitable format and using a suitable communication protocol. Video content from any given camera may be imported by the application server and concurrently forwarded to multiple destinations and end devices, according to the security system's configuration.

6. Real-Time Event-Triggered Video Support—In addition to on-line and real-time video monitoring, system 100 may also provide event-triggered video image transfer to allow users or monitoring services to evaluate alarm conditions. An event list of events of particular interest (events of particular significance, consequence or implication) may be predefined in APPLICATION SERVER 130 for each Gateway (for example for GATEWAY 120) with which it is in communication; provided that at least one camera is functionally connected to the gateway.

In further embodiments a “Post Event Video” function may be implemented. Since pictures and video images may be acquired and stored/recorded as part of the entire security system solution, the user may select one or more events observed from, or detected by, the local security unit (Gateway) to activate one or more specific cameras. The video data from the selected camera(s) may be sent to the application server or any other server to be processed and/or stored. Files containing video data may then be sent to other users, for example, as e-mail attachments.

Upon detection of event(s) by APPLICATION SERVER 130, APPLICATION SERVER 130 may check if the detected event(s) appear(s) in the predefined list of events and, if the detected event is in the list, APPLICATION SERVER 130 may cause a video channel to be opened between the camera(s), which may be defined in the events list for the detected event, to APPLICATION SERVER 130 that records the video content imported from these cameras for a pre-configured duration. If required or desired, the camera(s) may also transfer pre-event video content, which may be of great value because it may include images that where taken or recorded a short time before the event occurred and may assist in determining what triggered the event.

APPLICATION SERVER 130 may be configured to display images and video content to intended recipients (such as users and service provider(s)) by forwarding to them and/or to any pre-defined destination, an e-mail to which a video clip is attached. Alternatively or additionally, APPLICATION SERVER 130 may be configured to present the video content to intended users by forwarding an e-mail notification to the end user, service provider, and/or any pre-defined destination, which includes a Uniform Resource Locator (“URL”) link (URL—a string of characters conforming to a standardized format, which refers to a resource, such as a document or an image, on the Internet by its location) by which the user(s) may access the video content stored in the APPLICATION SERVER 130. Alternatively or additionally, APPLICATION SERVER 130 may be configured to display the images or video content to intended users by forwarding the images, pictures or video content, to the mobile phone of the user, service provider and/or to any pre-defined destination, by using, for example, mobile Multimedia Message Services (“MMS”). Alternatively or additionally, APPLICATION SERVER 130 may be configured to display the images, pictures or video content to intended users by forwarding a corresponding message to a service provider that may respond to the message by opening a viewer for watching the real-time video stream, though the video content may be displayed (also or only) at other times, as requested by the intended recipient.

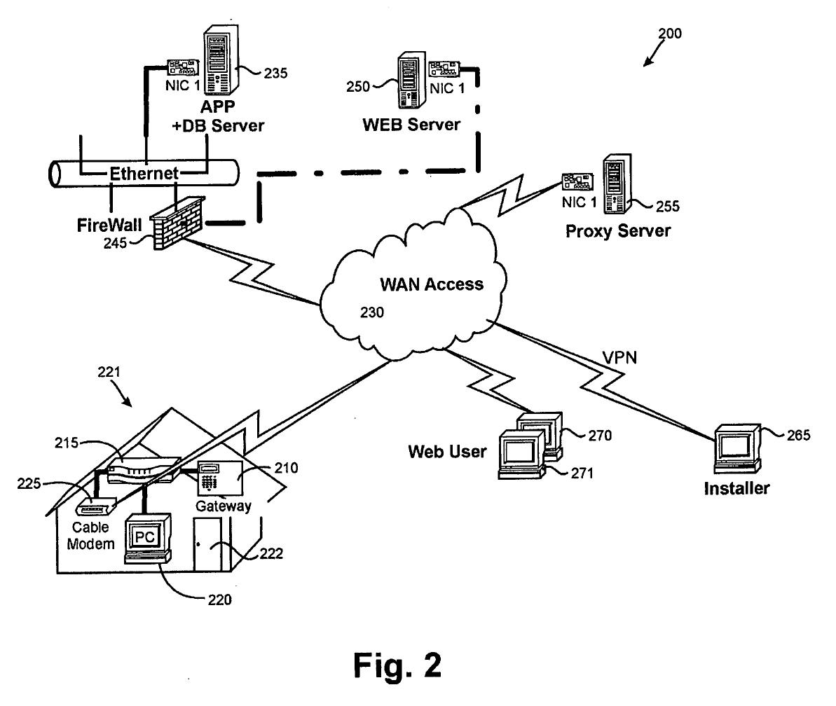

In some embodiments APPLICATION SERVER 130 may enable, for example, connect (or associate) intrusion system sensor(s) event(s) to the selection of corresponding media (video) clips to be sent to an end user, for example attached to an e-mail. In further embodiments APPLICATION SERVER 130 may enable, for example, splitting events in the application server and reach a decision as to which ones (events) go to the monitoring station as event report(s) and which ones go to end user(s) or any other intended recipient(s), for example attached to an e-mail. Security systems (and monitoring and event(s)-driven systems in general), which are based on a gateway such as GATEWAY 120 of FIG. 1 and an application server such as APPLICATION SERVER 130, may have different architectures, some of which are described in connection with FIGS. 2 through 6.

Reference is now made to FIG. 2, which illustrates an exemplary implementation of a security system (generally shown as 200), according to some embodiments of the present disclosure, Security system 200 may include a local control unit (gateway 210) connectable to one or more peripheral devices (not shown) that may be similar to the peripheral devices which are shown connected to GATEWAY 120 of FIG. 1. Gateway 210 may be connected to a router 215, or other network device, by a cable or wirelessly, and router 215 may be connected to a PC 220 and modem 225 that may be, for example, a cable modem, ADSL modem, network card, and the like. Gateway 210 may be functionally connected to application server 235 via WAN Access network 230, which may be, for example, the Internet, Application server 235 may be similar to, or function like, APPLICATION SERVER 130. Application server 235 may include a database (not shown), and/or a database server. Application server 235 may be protected from, or inaccessible by, unauthorized users or clients by firewall 245 or other suitable security means.

Web server 250 may be used as an ancillary server, to enable users, for example Web users 270 and 271, installer 265, and so on, to access application server 235. Installer 265 may use an application called Web Remote Programmer for remotely configuring and controlling Gateway 210. Application server 235 may authenticate users by using an authentication application, such as AUTHENTICATION 125 of APPLICATION SERVER 130 of FIG. 1, and, for example, only process authorized commands, instructions and other data, which may or may not be encrypted. Any type of data and information exchanged between a gateway and an application server may be encrypted by using any encryption technique or method known today, or any encryption technique or method that will be devised in the future. If required or desired, data and information exchanged between peripheral devices and the respective gateway, may be encrypted as well. These commands, or instructions, may be securely transmitted from application server 235 to gateway 210, to monitor the functionality and control the operation of Gateway 210 and, via Gateway 210, the controllable peripheral devices (not shown) connected to Gateway 210. Proxy Server 255 may be used for interfacing with as many as required service providers (third party applications).

Different types of peripheral devices may be used for protecting house 221. For example, a first video may be installed in such a way that most of the front side of house 221, including main door 222, are in its field of view (FOV). Other cameras may be installed inside house 221 for different purposes, depending on the required or desired security or monitoring level. For example, a camera may be installed in a nursery room for monitoring children activities.

The security system protecting, or monitoring, house 221 may be easily, conveniently and remotely, configured to operate according any one of numerous optional operation modes and, once a certain system configuration has been set, to easily, conveniently and remotely, change or update the security system's configuration. Several configurations will be demonstrated hereinafter, by way of examples, in connection with FIG. 2. According to a first example, a person wishing, for some reason, to enter house 221 while there is no one inside, may call the person living there (hereinafter referred to as client) and ask for his permission to enter the premises. In response to the call/request, the client may use his PC (for example Web User 271), a mobile phone (not shown) or laptop (not shown), all of which are only exemplary devices, to access (to log into) APP Server 235 (via WAN Access 230), by using the username and password assigned to him by the security system's administrator. Then, the client may use a browser to display a cameras menu by which he may control the operation of each controllable camera installed inside and outside his house 221. Then, the client may forward a command to Gateway 210, through APP Server 235, to switch on the camera (not shown), which optically covers the front side of house 221, and to establish, or open, a video channel between the camera to his display screen, whether it is of the PC, mobile phone or laptop. While the video channel is open, the client may see on his PC's (or phone's or laptop's) display screen the person, or only the person's face, and decide whether to let him enter house 221. An electromechanical device may be adapted to remotely open/close door 222. Accordingly, if the client decides to let the person enter house 221, the client may cause Gateway 210 to activate the electromechanical device to open door 222 by, by using the browser on his PC, mobile phone or laptop, to send an appropriate command to APP Server 235.

According to another example, the security system may be configured in a way that if a person approaches house 221, a presence sensor may be activated by the presence of that person, and an exemplary series of actions may result from the activation of the sensor, as is described hereinafter. Gateway 210 may get from the activated sensor (through a wire or wirelessly) an activation signal and forward the activation signal to APP Server 235. APP Server 235 may respond to the activation signal forwarded to it from Gateway 210 APP by identifying to which event (in a predefined events list) the activation signal refers. The rest of the steps may depend on a predefined series of actions relating, or associated with, the identified event. A predefined series of actions may include, for example, instructing Gateway 210 (by APP Server 235) to activate (switch on) one or more video camera that are (most) relevant to the vicinity covered/protected by the sensor initiating the activation signal. If the activated camera(s) can be rotated, then Gateway 210 may optionally cause the activated camera to rotate until the intruder may be clearly seen, and thereafter Gateway 210 may optionally cause the activated camera to keep track of the intruder (within the physical angular limits of the camera.

Predefined series of actions may further include sending (by APP Server 235) a message to the client's PC or mobile phone (for example), for notifying him of a potential intrusion, and also video images of the person who activated the presence sensor. At this point, the client may have several options. For example, if the client can recognize the person (in the video images) as a person who is allowed to enter house 221, the client may use his mobile phone (for example) to send a cancel, or abort, message to APP Server 235. APP Server 235 may respond to the cancel, or abort, message by closing the video channel and by instructing Gateway 210 to deactivate (switch off) the camera(s). However, if the client recognizes the person in the video images as an intruder, the client may send an intrusion message to APP Server 235, which may then send a corresponding message to a police station (not shown), directly or via Proxy Server 255. Optionally, APP Server 235 may send an intrusion message to the client, and the client may decide to watch the video images on real-time or later, or he may decide not to watch the video images at all.

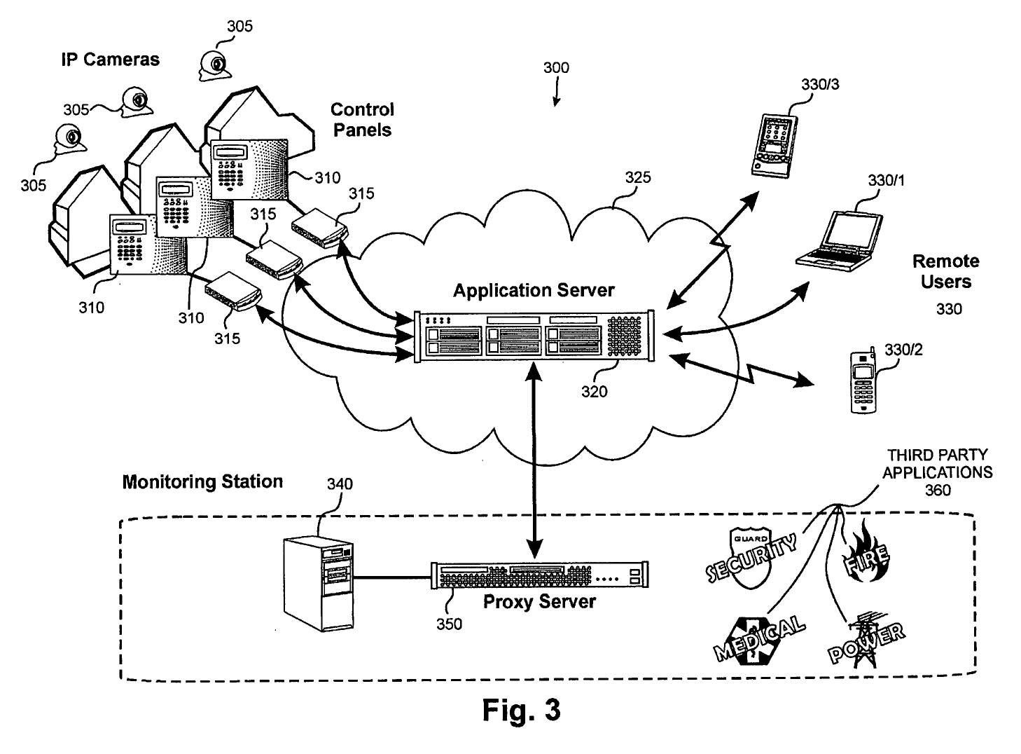

Reference is now made to FIG. 3, which illustrates a security system (generally shows as 300), according to some other embodiments of the present disclosure. System 300 may include local control units (such as gateways 310), to enable local control and monitoring of peripheral devices, for example IP cameras 305, which may be functionally connected to the respective gateway 310. Gateways 310 may be coupled to IP interfaces, for example to routers 315, to route data from the users' premises to Application server 320, using a wire and/or wireless connection. Application server 320 may exchange data with remote users' devices 330/1, 330/2 and 330/3, for example via the Internet (to laptop 330/1, for example), cellular network (to mobile phone 330/2 and to PDA 330/3, for example), or via any other suitable data communications network (generally shown as 325). Users' devices 330 may receive data in the form of messages, alerts, and so on, on their PDAs, mobile phones and/or personal computers, and so on, via email, SMS, instant messages or in other suitable forms.

Users may access Application server 320 (for example by using laptop 330/1, mobile phone 330/2 or PDA 330/3) via the Internet using an IP network connection (for example, Ethernet) or using a wireless connection (for example, GPRS). Application server 320 may be functionally connected via data communications network 325, which may be, for example the Internet, to a proxy server 350 associated with and/or within a monitoring station or system 340. Proxy server 350, which may be a broadband receiver, may be functionally connected to one or more third party applications, for example existing or legacy computer systems of service providers (security monitoring firms, emergency services, electricity corporations, and other services providers, collectively designated as THIRD PARTY APPLICATIONS 351). Proxy server 350 may be located at service provider premises, for example, or it may be located geographically apart from service provider premises. Proxy server 350 may be also part of application server 320. FIG. 3 shows a security system in which one proxy server (Proxy Server 350) is utilized by several service providers (THIRD PARTY APPLICATIONS 360).

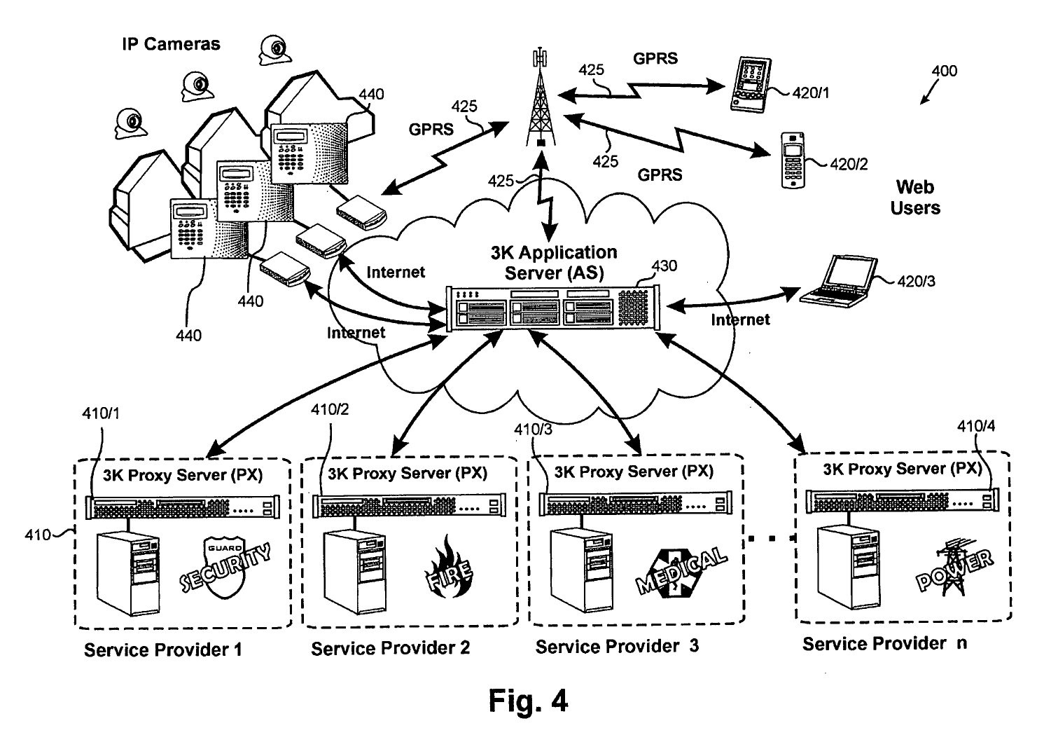

Reference is now made to FIG. 4, which schematically illustrates a security management system (generally shown as 400) according to some other embodiments of the present disclosure. End users may access application server 430 (for example by using PDA 420/1, mobile phone 420/2 or laptop 420/3) using an IP network connection (for example Ethernet), or using a wireless connection (for example GPRS 425). Application server 430 may communicate with Gateways 440 using an IP connection or a wireless connection. Application server 430 may communicate with one or more proxy servers 410 using IP connections and/or wireless connections. Proxy servers 410 may be located, for example, at a service provider's premises or they may be located geographically apart from a service provider's premises. Examples of service providers with which Application Server 430 may communicate include security firms (via Proxy Server 410/1), fire brigades (via Proxy Server 410/2), medical services (via Proxy Server 410/3), power services (via Proxy Server 410/4), and other suitable service providers.

Reference is now made to FIG. 5, which schematically illustrates another implementations of a security system (generally shown as 500). Gateway 510 may include several modules. For example, Gateway 510 may include a TCP/IP communication module (called Ethercom and shown at 511) for facilitating TCP/IP based communication, home automation module (shown at 512), GSM/GPRS module (shown at 513). Gateway 510 may further include an integrated keypad or an interface for interfacing with a remote keypad (by a cable or wirelessly). For example, wireless keypad 514 is symbolically shown communicating with the main board (control panel) 515 of Gateway 510. Gateway 510 may further include other modules or control components, depending on the required or desired configuration. Gateway 510 may be adapted to communicate with devices 530. For example, Gateway 510 may wirelessly (or through wires) receive and/or transmit signals from/to sirens such as wireless siren 530/1 and wired siren 530/4, sensors such as wireless sensor 530/2 and wired sensor 530/8, smart keys such as smart key 530/3, electronic key fobs such as key fob 530/5, repeaters such as repeater 530/6, IP cameras such as IP camera 530/7, Transmitters (remote controllers) 530/8, and/or other suitable devices. The devices collectively designated as 530 and Wireless Key pads 514 may communicate with gateway 510 using any appropriate wired or wireless technology, though Transmitters 530/8 may do so through Repeater 530/6 (for example).

Ethercom module 511 (a TCP/IP and PSTN module) may allow gateway 510 to exchange data, information and control messages with application server 520, for example over the Internet (shown at 521), through a router or a ADSL or cable modem 522. In particular, gateway 510 may be configured or programmed by (or remotely through) application server 520 by using the TCP/IP part of TCP/IP and PSTN module 511. A user may interact with security system 500 by using PC 540 which may communicate with Application Server 520 over the Internet 521 (for example), cellphone 541 or PDA 542, which may communicate with Application Server 520 over cellular network 543 (for example by using GPRS standards). PC 550 may be utilized by an installation/service company which may wish to access Gateway 510 remotely over the web (shown at 521) using special TCP/IP based application, such as Remote Programmer application, for various reasons, for example for software upgrading of Gateway 510, default(s) setting of Gateway 510, for configuration and so on. Proxy Server 560 may be used as a mediator between TCP/IP based messages send by Gateway 510 through Application server 520 and the legacy 3^{rd} part applications such us a burglary monitoring automation software (not shown). Central Station Management Software 570, which is a legacy software, may facilitate managing gateways such as Gateway 510. In addition to the web-based bi-directional communication between Gateway 510 and Application server 520 and Proxy server 560, Gateway 510 may include a PSTN interface, which may or may not be part of the TCP/IP module 511, for allowing PSTN-based bi-directional communication, generally shown at 580, 581 and 582 (according to some embodiments only as a backup communication path) between Gateway 510 and Central Station Receiver (CSR) 583 which may be a third party that intermediates between Gateway 510 and legacy Central Station Management Software 570. CSR 583 is a legacy hardware adapted to convert Gateway 510 reports to a suitable data format that can be delivered over to, and be understandable by, CSMS 570. A Gateway 510 message may be forwarded over PSTN 580 to CSR 583 and from CSR 583 to CSMS 570 (after being converted into a suitable format), and a message may be sent backwards in the same path: from CSMS 570 to Gateway 510 through CSR 583 and PSTN 580, of course after proper conversion into a suitable data format.

Capabilities of the security system disclosed herein may be utilized for performing security-oriented tasks and non-security oriented. According to a first non-security oriented example, a user, or client, of security system 500 may want to remotely switch on a water boiler before coming home, so that he may get a hot shower as soon as he gets home. According to another non-security oriented example, a user may want to remotely switch on the air-condition system in his house so that when he gets home the average temperature in the house will be cozy. In order to heat water (or switch on the air-condition system), the user may use a cellphone (for example) such as cellphone 541 to send a corresponding message to GSM module 513 that will cause, for example, Home Automation Module 512 to activate the water boiler (or the air-condition system) during the prescribed time. If the water boiler (or the air-condition system) is a smart device/system, Home Automation Module 512 may send control data to the (smart) water boiler (or the air-condition system) over a corresponding data bus. If the water boiler (or the air-condition system) is not a smart device/system, the power cable of the water boiler (or the air-condition system) may be plugged into, or otherwise connected to, a power distribution box (not shown) that may be controlled by Home Automation Module 512 (for example). According to a first security-oriented example, a user (while away from home, may want to switch on and off electric lamps, at different rooms of his house and at different times, for making an impression that someone is in the house, whereby to deter potential intruders. In order to make a more realistic impression that someone is in the house, the user (the house owner or resident, or an authorized person) may set, or predetermined (locally or remotely), a specific order at which lamps are switched on and off. In order to make the impression even more realistic, the user may also decide to remotely switch on and off a television set and/or a radio set.

Home Automation Module 512 may include wired and/or wireless bi-directional interfaces for enabling monitoring and controlling of different home appliances. For example, Home Automation Module 512 is symbolically shown controlling (shown at 517) lamp 516, by using X10 communication standard. X10 is an industry standard for communication among devices, which is used for home automation. It primarily uses power line wiring for signaling and control, where the signals involve short radio frequency (“RF”) bursts that represent digital information. The X10 communication standard is more fully described, for example, in “How X10 Works” (at the World Wide Web site SmartHomeUSA.com). Home Automation Module 512 may alternatively use the wireless ZigBee standard, a set of high level communication protocols designed for wireless personal area networks (WPANs). A user may send a message to Gateway 510 (such as by using Cellphone 541 or PDA 542, or over Web 521) that will cause Home Automation Module 512 to activate or deactivate specific home appliances (for example lamp 516) according to a wanted or predetermined routine, scheme or policy. The user may send messages to Gateway 510 to enable or disable Home Automation Module 512, or to change, modify or update the set of home appliances to be activated/deactivated by Home Automation Module 512, and also the home appliances' activation and deactivation routine, scheme or policy on an individual basis.

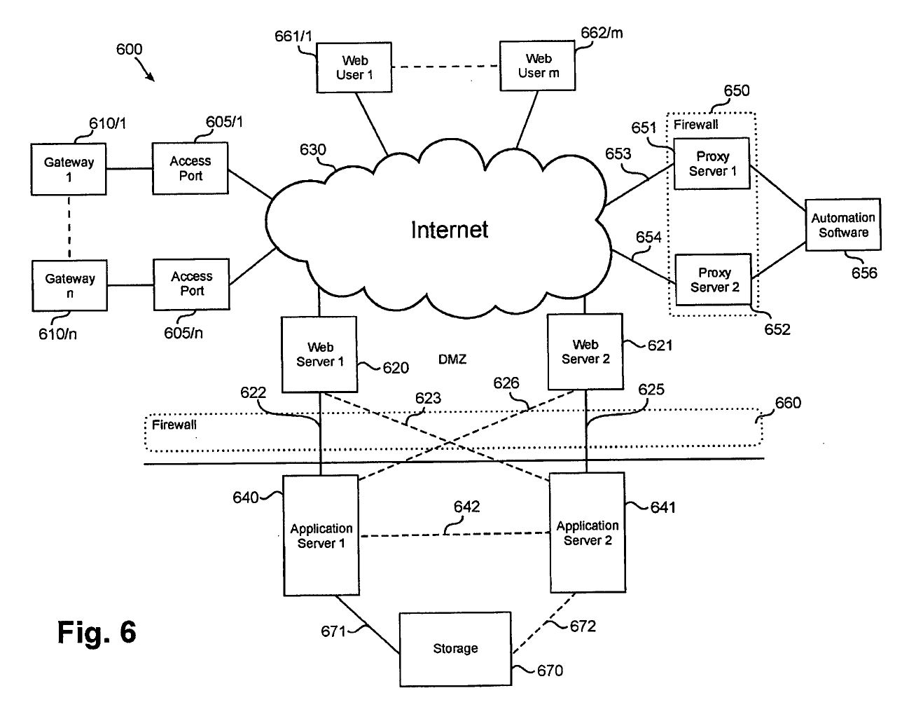

Reference is now made to FIG. 6, which schematically illustrates, by way of example, an implementation of a security management system, generally shown as 600, according to some embodiments of the present disclosure. System 600 may include n gateways (Gateways 610/1 to 610/n), each of which may be similar to, and function like, GATEWAY 120 of FIG. 1, for example. Each one of gateways 610/1 to 610/n which may be associated with a different protected property or area, may be connected to Internet 630 through a respective access port 605/1 to 605/n, which may be a cable, ADSL modem and the like. Web servers 620 and 621 may enable authorized users to remotely access Application Servers 640 and/or 641. System 600 may be independently accessed (over Internet 630) by m users (m>n), Web User 1 (shown at 661/1) through Web User m (shown at 661/m), each of which may have been registered in system 600 as being authorized to obtain data, information, messages, indications or alert signals from Application Servers 640 and 641, and/or to reconfigure, manipulate or otherwise operate or control the operation of one of Gateways 610/1 through 610/n with which the user accessing system 600 is associated.

System 600 may be configured to provide any desired level of redundancy, for making it a fault tolerant environment, by using Hot Swap and/or Fail Over features. “Hot swap” is a desired feature of fault tolerant systems built with redundant drives, circuit boards, power supplies and servers that run 2417 (twenty four hours a day, 7 days a week). When a component fails and the redundant unit takes over, the bad component may be replaced without stopping the system operation. “Failover” refers to the invoking of a secondary system to take over when the primary system fails. Up-to-date copies of all required data and applications are maintained on the secondary system in order to respond immediately if the primary system becomes unusable.

According to some embodiments of the present disclosure a security system may include two or more application servers similar to APPLICATION SERVER 130 of FIG. 1, for providing redundancy capabilities. FIG. 6 schematically illustrates a security system with two application servers: Application Server 1 (shown at 640) and Application Server 2 (shown at 641). One application server, for example Application Server 640, may be used as a primary application server, whereas another application server, for example Application Server 641, may be used as a secondary, or backup, application server. That is, if, for any reason, Application Server 641 fails to function, Application Server 641 may seamlessly take its place (symbolically shown at 642), for providing to the system clients a continuous, uninterrupted, service.

Likewise, for redundancy purposes security system 600 may include two web servers: Web Server 1 (shown at 620) and Web Server 2 (shown at 621), each of which may communicate with each one of Application Servers 640 or 641. For example, Web Server 620 is shown in FIG. 6 normally communicating (shown at 622) with Application Server 640 and optionally (shown at 623) with Application Server 641. Web server 621 is shown in FIG. 6 normally communicating (shown at 625) with Application Server 641 and optionally (shown at 626) with Application Server 640. Therefore, assuming that at least one web server (for example Web Server 620) and at least one application server (for example Application Server 641) function normally at any given time, the service rendered by security system 600 will be substantially free of interferences. Web Servers 620 and 621 may communicate with Application Servers 640 and 641 through Firewall 660, which may provide a first level of protection from unauthorized users. Likewise, an authorized user, for example Web User 661/1, may be granted an access to Application Servers 640 or 641 (whichever is currently active) through Firewall 660.

According to some embodiments the functionality of Web Server 620, Application server 640 and Storage 640 (or part of Storage 640) may be implemented using one server, for example Application Server 640, to minimize the costs involved in running multiple servers. Further, all communications between application server 640 and Gateways 610 (for example) may be based on SSL encryption or on other suitable secure communication protocol. System 600 may use data certificates or other suitable authentication means for verifying the identity of the various system elements. Further, system 600 may enable Dynamic Load Balancing, which means splitting the web users access between Web Server 1 (620) and Web Server 2 (621) for reducing the traffic load to the application servers, and/or Remote Server Administration, which means that managing Web Server 1 (620) and Web Server 2 (621) can be done by, or through, a remote site or device.

Storage 670, which may have the same, or similar, functionality as DATABASE 132 in FIG. 1, may be defined according to the system requirements. For example, Storage 670 may reside within one application server (within Application Server 640, for example), or its functionality may be distributed among several application servers. A stand-alone storage such as Storage 670 (as demonstrated in FIG. 6) may be used in relatively large-scale security systems. Storage 670 is accessible to Application Servers 640 and 641 (shown at 671 and 672, respectively).

Conceptually, Proxy Servers 651 and 652 each may function essentially like Central Station Receiver 583 of FIG. 5, except that Proxy Servers 651 and 652 communicate (shown at 653 and 654, respectively) IP data type over Internet 630, whereas Central Station Receiver 583 communicates data over PSTN network. Proxy Servers 651 and 652 may be protected by a firewall application (designated as Firewall 650).

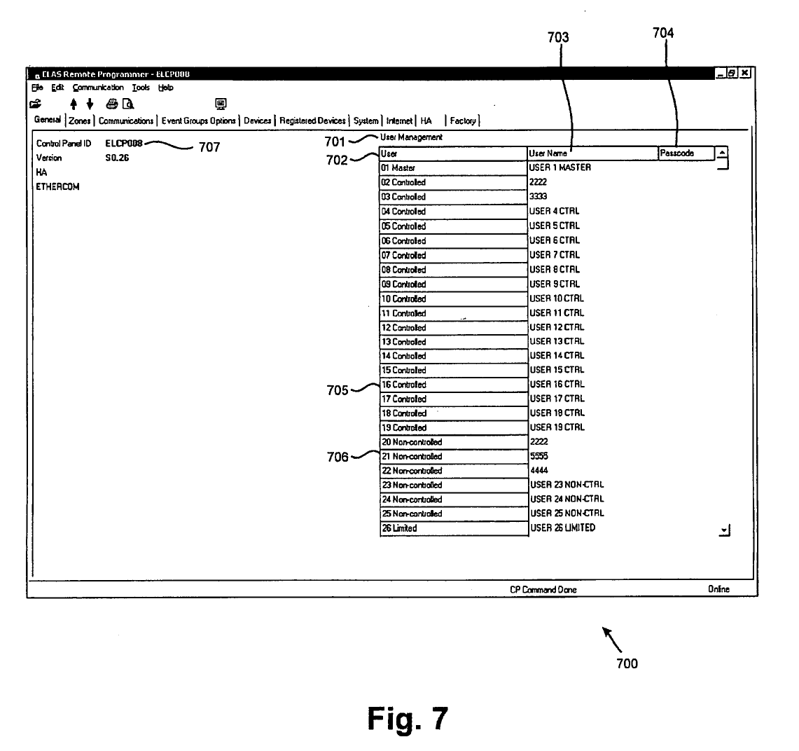

Referring now to FIG. 7, an exemplary computer screen (generally shown at 700) of TCP/IP-based Remote Programmer application is depicted according to some embodiments of the present disclosure. Screen 700 is shown displaying an exemplary list of user codes of users registered to a gateway such as gateway 310 of FIG. 3. Screen 800 may include a user general management table, such as User Management table 801, per control panel (gateway). User Management table 701 may include a general list of all users (shown at 702) registered to the security system's control panel (gateway), with their respective user names (shown at 703) and pass codes (shown at 704). Users' list 702 may specify, per user, whether the user is controlled or not. If a controlled user arms or disarms a control panel (gateway), the arm/disarm operations will be reported to a monitoring station (for example to Central Station Management PC 570 of FIG. 5), whereas arming and disarming of a control panel (gateway) by a non-controlled user will not be reported to the monitoring station. For example, user no. 16 (shown at 705) is indicated as being controlled, whereas user no. 21 is (shown at 706) is indicated as being non-controlled. The identification code of a given control panel may also be displayed on screen 700 (shown as Control Panel ID 707).

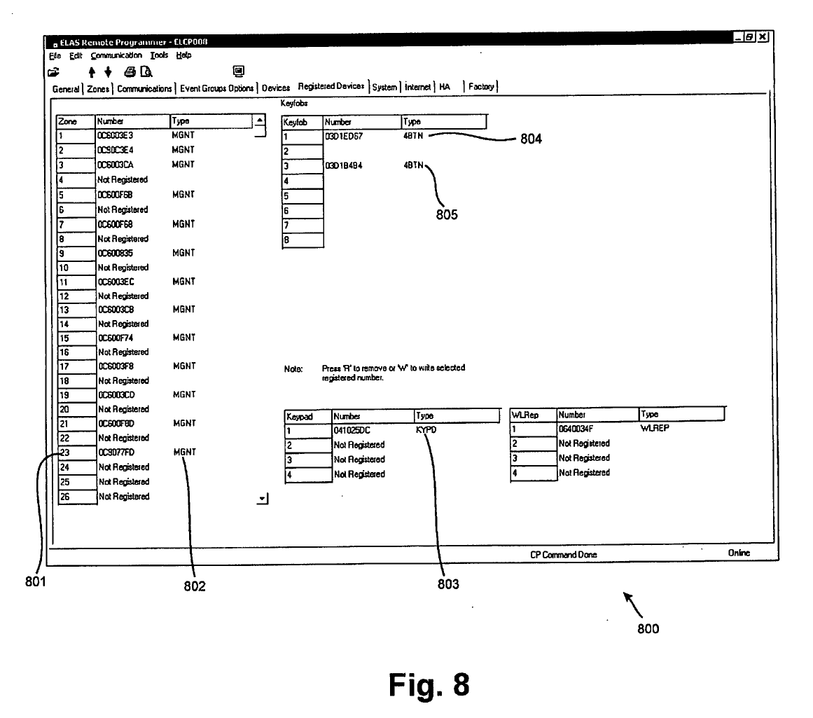

Referring now to FIG. 8, another exemplary computer screen (generally shown as 800) of an Installer or TCP/IP-based Remote Programmer application is depicted, which demonstrates a way for viewing, monitoring and modifying registered sensors/devices associated with a security control panel (gateway) according to some embodiment of the present disclosure. Screen 800 visualizes registration of peripheral device per zones. For example, in zone number 23 (shown at 801) a magnetic sensor (shown as MGNT, at 802) has been installed and, therefore, it is shown as registered. Likewise, one keypad (shown as KYPD, at 803) is shown registered. Likewise, two key fobs (shown as 4BTN, at 804 and 805) are also shown registered. Keypad 803 and key fobs 804 and 805 will allow a user to locally operate (switch on and off, changing configuration and so on) the local control unit(s).

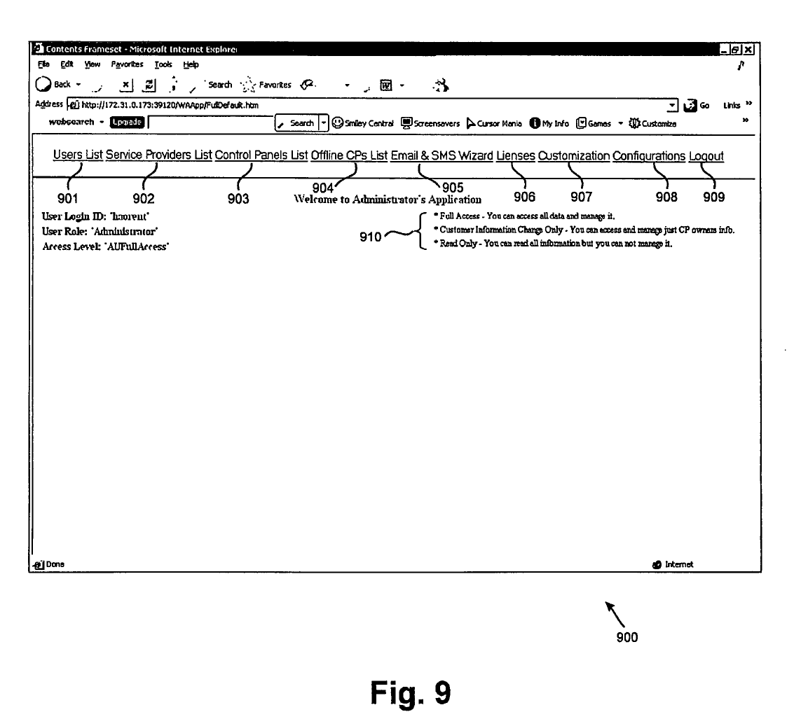

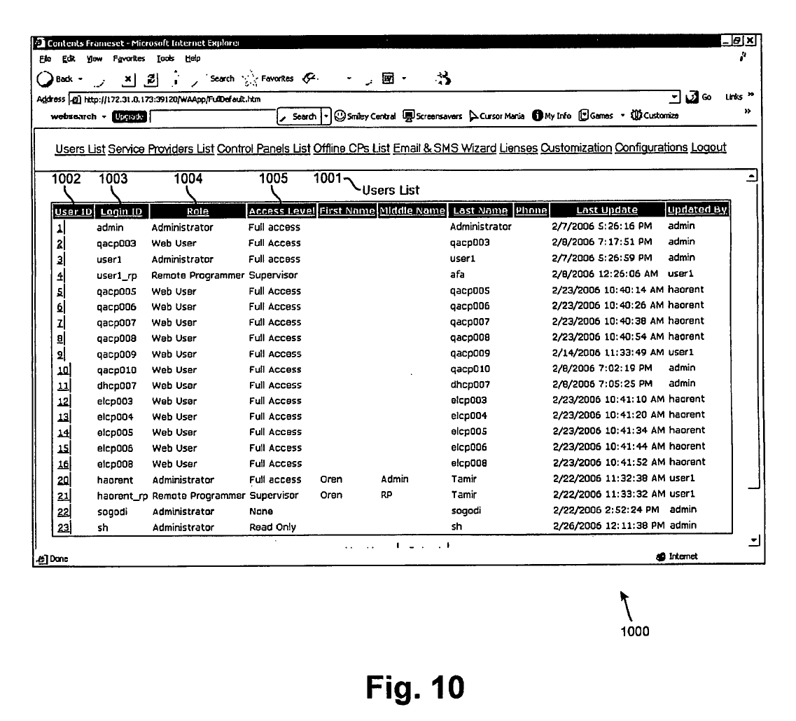

Referring now to FIG. 9, an exemplary administration main computer screen (generally shown as 900) is depicted, which may be used for operating an application server such as APPLICATION SERVER 130. Computer's screen 900 is an exemplary general administration page of an application server such as APPLICATION SERVER 130, which allows the application server administrator(s) to register, operate and configure security control panels (gateways), remote web user, type of service providers and so on. A tool bar is shown displaying several exemplary options among which options the logged-in server administrator may select: (1) Users List (shown at 901), for displaying all registered users (for example remote Web Users 661/1 to 661/m, which may access security system control panels (gateways) connected to the system's server(s), application server(s) administrators, and so on); (2) Service Providers List (shown at 902), for displaying all registered 3^{rd} party applications type service providers; (3) Control Panels List (shown at 903), for monitoring, controlling and reconfiguring control panels; (4) Offline CPs List (shown at 904), which is a list of security controlled panels (gateways) which are registered at the application server (for example at APPLICATION SERVER 130) but for some reason are disconnected, for example because the internet line/connection is cut, or the security system malfunctions, or because of any other reason for which the security system is unable to report events to APPLICATION SERVER 130 (for example); (5) Email & SMS Wizard (shown at 905), for enabling or disabling various alert options (content and recipients options, for example) associated with emails and SMS messages; (6) Licenses (shown at 906), for giving the application server(s) administrator(s) an option to enable/disable various (license-dependent) features of security system 600 of FIG. 6 (for example) according to a license granted to the administrator(s). Exemplary license-dependent features that can be enabled/disabled by administrator(s) are: Video Look-In (for zooming in and out), E-mail & SMS Alerts, Home Automation functions, and so on; (7) Customization (shown at 907), for customizing the security system according to the needs of remote web user(s), such as Web Users 661/1 to 661/m; (8) Configurations (shown at 908), for configuring various and independent aspects or features of the security system functionality, and (9) Logout (shown at 909), for exiting the application server's administration section.

Screen 900 may also display a legend such as legend 910. According to exemplary legend 910 “Full Access” means that the user can access all application server's data and manage (for example display, edit and delete) it, “Customer Information Change Only” means that the user can only access and manage information relating control panels (CPs), and “Read Only” means that the user can only read all the available information but he cannot manage any of it.

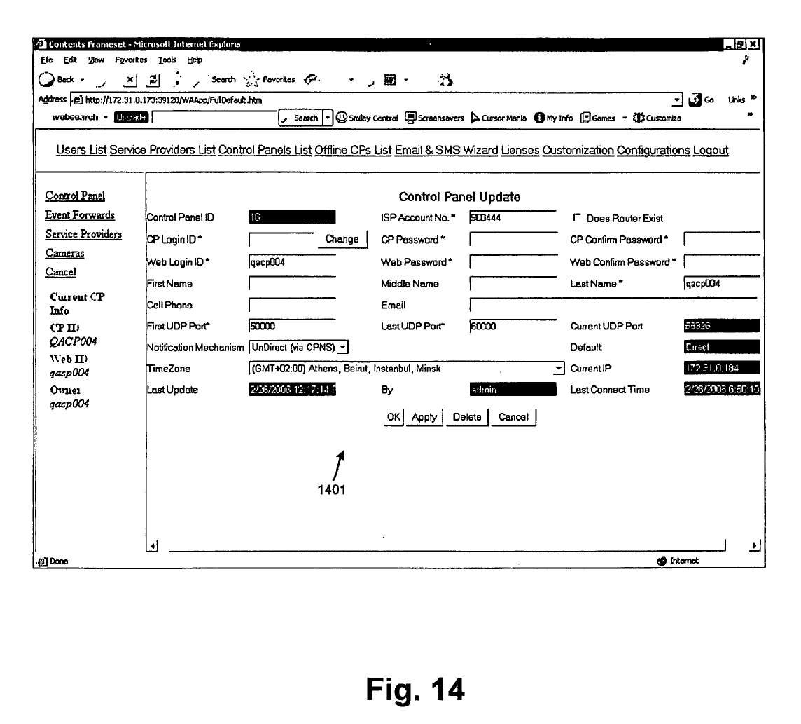

If a logged-in administrator(s) selects in screen 900 the “User List” option (shown at 901 in FIG. 9), then a users list may be displayed to him, which may look like, or may be similar to, the users list 1001 shown displayed in screen 1000 of FIG. 14. A user list may include a user identification (ID) number (shown at 1002), login ID (shown at 1003), the user's role (shown at 1004), user's granted access level (shown at 1005), and so on.

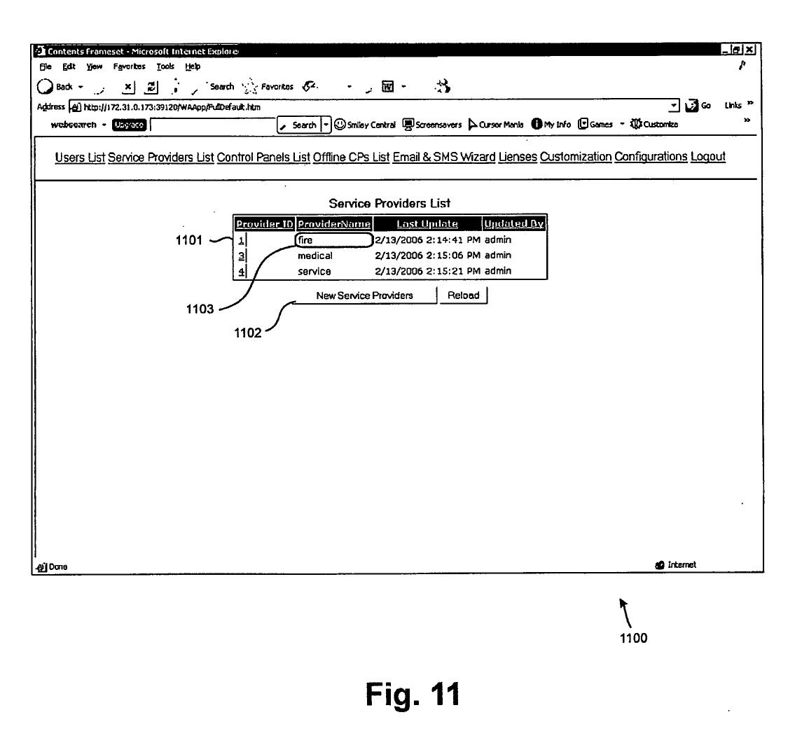

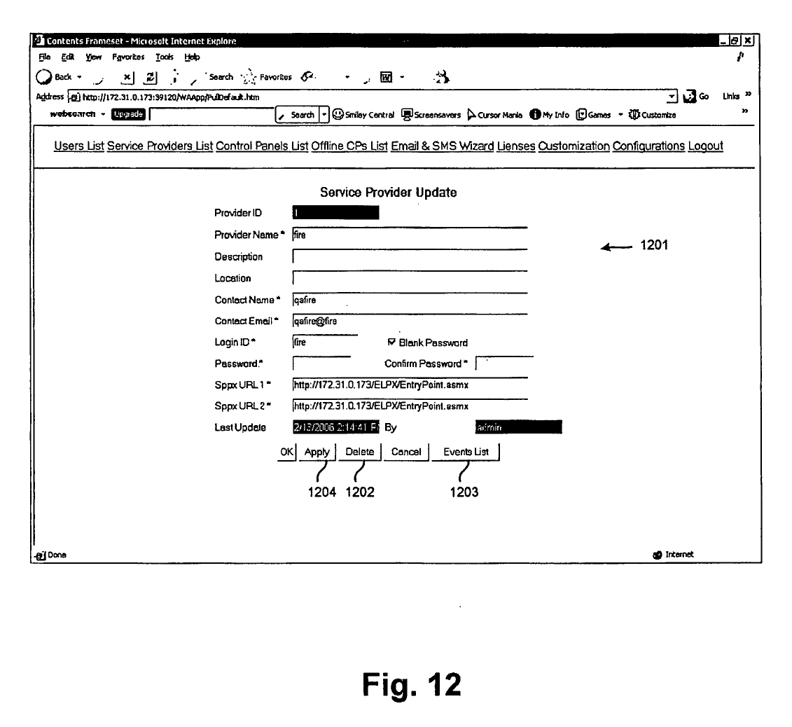

If a logged-in administrator(s) selects in screen 900 the “Service Providers List” option (shown at 902 in FIG. 9), then a service provider list portlet may be displayed to him, which may look like, or may be similar to, the Service Provider List portlet 1101 shown displayed on screen 1100 of FIG. 11. By “Service Provider” is meant an entity to which control panel(s) related events are directed through an application server such as APPLICATION SERVER 130. Referring again to FIG. 1, the Third Part Application 155 is an exemplary service provider. Exemplary list 1101 is shown including fire, medical and (other type of) service providers. The application server(s) administrator(s) may add a new service provider to Service Providers List 1101, such as by clicking New Service Providers box 1102. If the administrator(s) wants to update details relating to a specific service provider, the administrator(s) may click on the name of that service provider to open a new portlet. For example, if the administrator(s) wants to update details relating to the fire service provider shown at 1103 in FIG. 11, then the administrator(s) may click on box 1103, which will result in the opening of a service provider update portlet such as Service Provider Update portlet 1201 of FIG. 12. The administrator(s) may use Service Provider Update portlet 1201, for example, to edit or update details, delete the service provider (shown at 1202), display events associated with that service provider (shown at 1203), apply updates (shown at 1204), and so on.

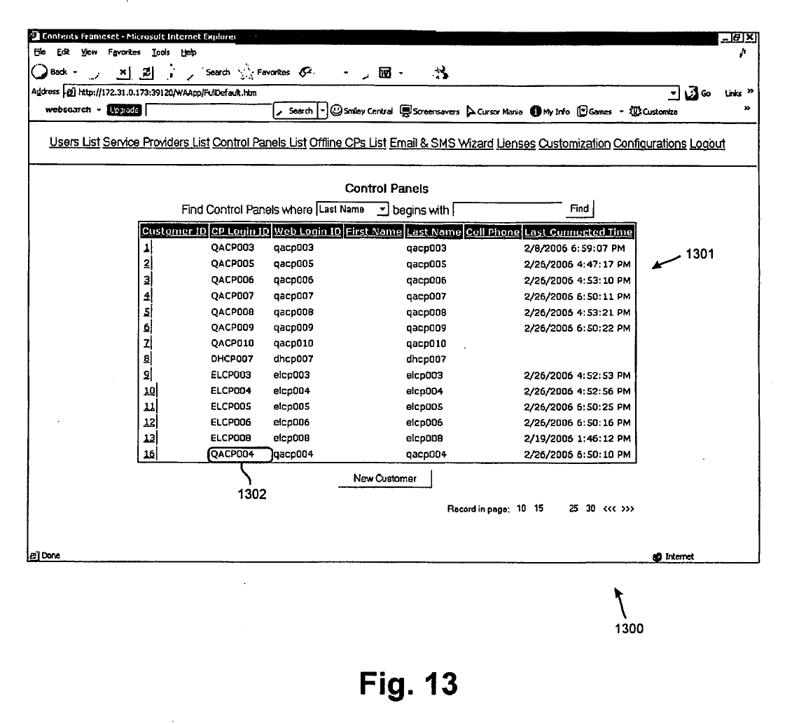

If a logged-in administrator(s) selects in screen 900 the “Control Panels List” option (shown at 903 in FIG. 9), then a control panels' list may be displayed to him, which may look like, or may be similar to, control panels list 1301 shown displayed on screen 1300 of FIG. 13. Exemplary list 1301 is shown including general data of available control panels. If the administrator(s) wants to delete a control panel, or to update details thereof, the administrator(s) may click on the name of that control panel to open an update window. For example, if the administrator(s) wants to update details relating to the 16^{th} control panel in Control Panels list 1301, then he may click, for example, on the relevant CP Login ID (shown at 1302), which will result in the opening of a control panel update window such as the Control Panel Update window 1401 shown in FIG. 14.

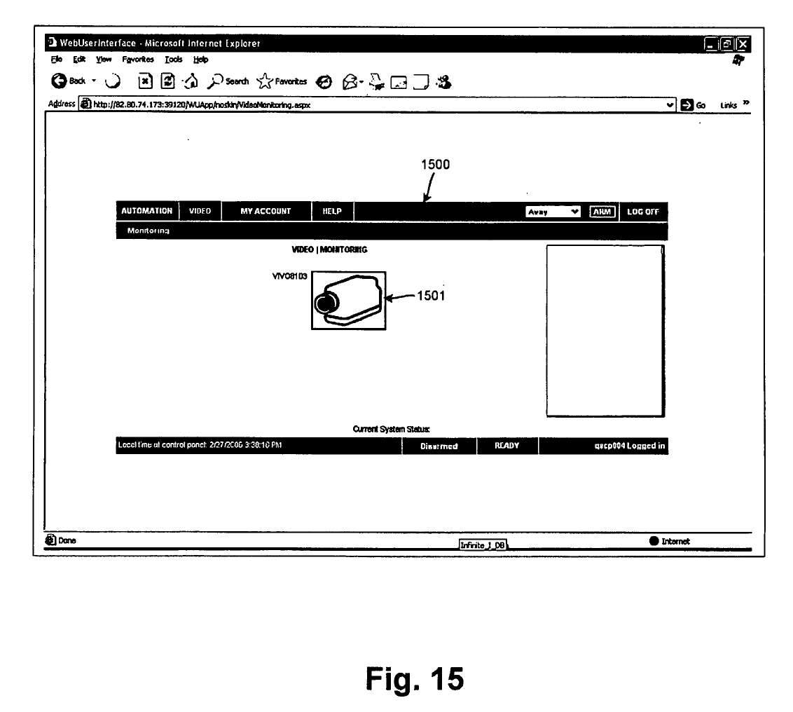

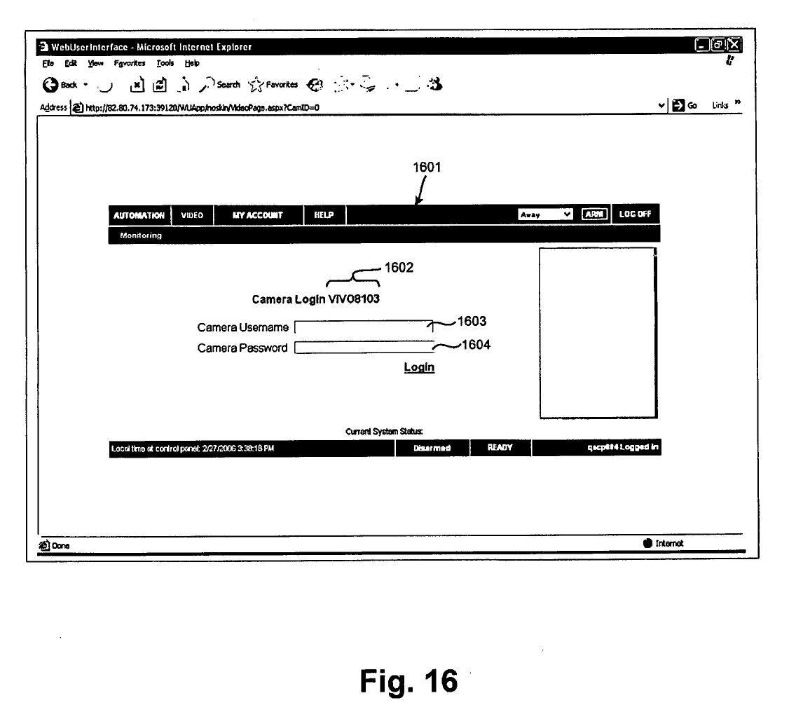

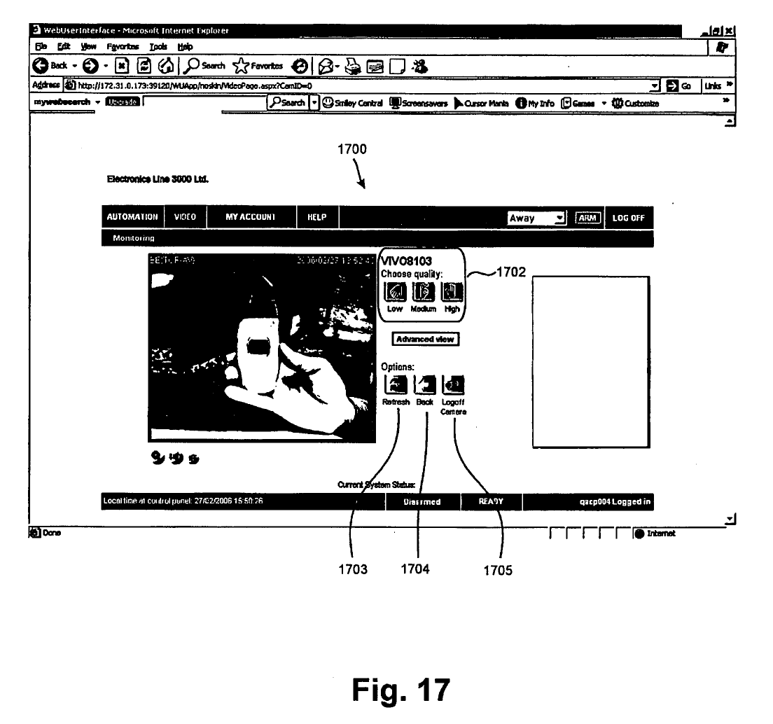

Referring now to FIG. 15, an exemplary general video management portlet (generally shown at 1500) is depicted according to some embodiment of the present disclosure. Exemplary portlet 1500 is shown depicting one camera icon (shown at 1501), which means that the security system associated with the logged-in user includes only one camera (denoted, according to this example, as VIVO8103). Upon clicking on camera icon 1501, a log-in portlet may be opened, which may look like, or may resemble, log-in portlet 1601 of FIG. 16. Log-in portlet 1601 may include the camera's name (in this example VIVO8103, shown at 1602). In order to display pictures or video images originating from the camera whose icon is shown in FIG. 15 at 1501, the user may have to enter the camera's username and/or password (shown at 1603 and 1604, respectively). After successful login, a new portlet may open, which may look like, or may resemble, portlet 1700 of FIG. 17. Referring now to FIG. 17, the pictures or video images originating from the camera associated with camera icon 1501 of FIG. 15 may be displayed, in real-time or after some delay, in a desired picture area (shown at 1701) whose location and size in portlet 1700 may be set or configured as desired by the user or by the application server administrator(s). The user may select between low, medium and high picture quality (shown at 1702). The user may further choose to refresh pictures or video images (shown at 1703), display previously displayed pictures or video images (by clicking on “Back”, shown at 1704), or exit portlet 1700 (by clicking on “Logoff Camera”, shown at 1705).

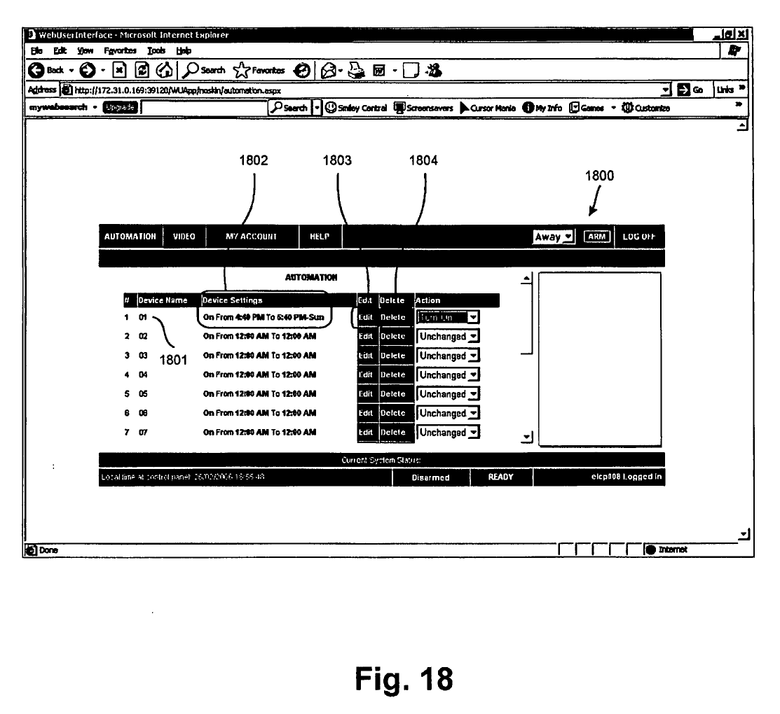

Referring now to FIG. 18, an exemplary general Home Automation window (generally shown at 1800) is depicted according to some embodiments of the present disclosure. Exemplary portlet 1800 is shown displaying general data of seven Home Automation devices. For example, device 01 (shown at 1801) is shown, by way of example, programmed, or set, to turn on at 4:40 and turn off at 5:40 on Sundays (shown as “Device Settings” at 1802). The user may set different times, for example by clicking on “Edit” (shown at 1803), or delete any data relating to that Home Automation device (shown as “Delete” at 1804).

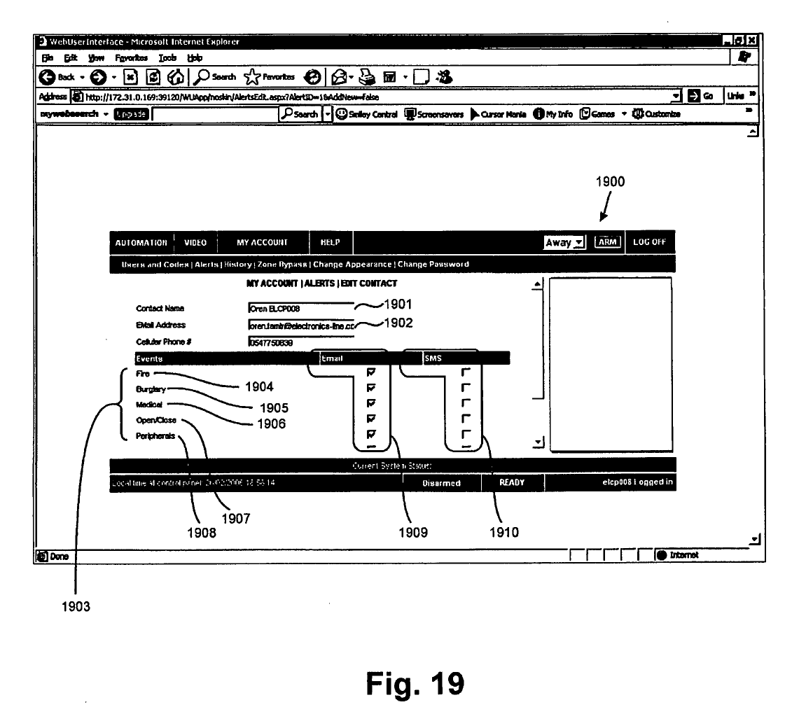

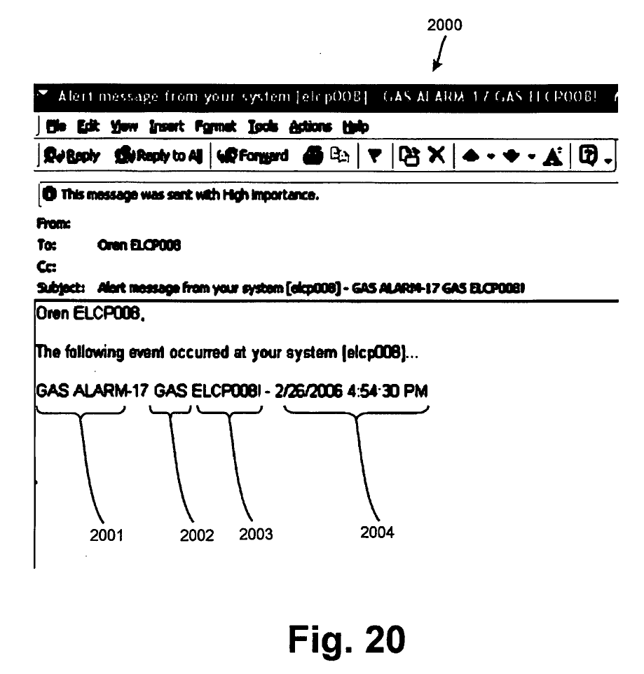

Referring now to FIG. 19, an exemplary general web user's messages configuration window (generally shown as 1900) is depicted according to some embodiments of the present disclosure. Exemplary window 1900 is shown displaying data relating to a message recipient and to event reporting options. For example, a client called Oren (shown at 1901), whose e-mail address is shown at 1902, may decide to receive email and or SMS messages relating to any one of the events collectively designated by 1903. According to exemplary window 1900, the user will receive any message originating from fire events (shown at 1904), burglary events (shown at 1905), medical events (shown at 1906), open/close states of certain sensors or detectors (shown at 1907) and ant event relating to the peripheral devices (shown at 1908). The messages relating to events 1904 through 1908 will be forward to the user by email (Email boxes are shown, at 1909, checked for these events), but (according to this example) not as SMS messages (SMS boxes are shown, at 1910, unchecked for these events). An exemplary email message is shown in FIG. 20.

Referring now to FIG. 20, an exemplary email message is shown according to some embodiments of the present disclosure. Exemplary window 2000 is a customized email format used to forward security, and, in general, events-related alarms and other types of messages. A typical message may include the type of alarm (GAS ALARM in this example, shown at 2001), events group or type (GAS in this example, shown at 2002), the name or code of the local control unit originating the message (ELPCP0081 in this example, shown at 2003) and the date and time of the message (2/26/206 4:54:30 PM, in this example, shown at 2004).

The foregoing description of various embodiments of the present disclosure has been presented for the purposes of illustration and description. It is not intended to be exhaustive or to limit the present disclosure to the precise form disclosed. It should be appreciated by persons skilled in the art that many modifications, variations, substitutions, changes, and equivalents are possible in light of the above teachings. It is therefore intended that the appended claims and claims hereafter introduced be interpreted to include all modifications, permutations, additions and sub-combinations as are within their true spirit and scope.

What is claimed is:

1. A system for remote secure management of applications, the system comprising an application server enabled to be a single junction for data transfer between a gateway and end user(s).

2. The system according to claim 1, wherein the gateway is functionally coupled to one or more peripheral devices, each of which may be configured, controlled or monitored by said gateway.

3. The system according to claim 2, wherein peripheral device(s) forward data or signal(s) to the gateway responsive to, or in association with, respective event(s).

4. The system according to claim 1, wherein end user(s) is one or more of end user(s), third party service provider(s), third party service(s)/application(s), system owner(s), system manager(s) and emergency service(s)/application(s).

5. The system according to claim 2, wherein peripheral device(s) is/are coupled to the gateway wirelessly or by cable(s).

6. The system according to claim 1, wherein the gateway comprises:
an TCP/IP and PSTN module for enabling IP and PSTN modem communication;
a home automation module for receiving information from and controlling the operation of home appliance(s);
a GSM module for facilitating GSM type communication with end user(s) device(s); and
a control module for communicating with peripheral device(s) and controlling said TCP/IP and PSTN, home automation and GSM modules.

7. The system according to claim 3, wherein data, message(s) or event report(s) is/are transmitted from the application server to end user(s) as corresponding SMS(s) or e-mail(s).

8. The system according to claim 6, wherein the gateway is configured or programmed by, or remotely through, the application server, through use of the TCP/IP module.

9. The system according to claim 1, further comprising a proxy server adapted to interface between the application server and third party application(s).

10. The system according to claim 9, wherein the third party application(s) is legacy system(s) or any other monitoring application(s).

11. The system according to claim 2, further comprising a web server coupled to the application server and adapted to allow an authorized end user to control or configure the gateway.

12. The system according to claim 11, wherein the web server is incorporated into, affiliated with or embedded in the application server.

13. The system according to claim 1, wherein the application server and gateway each comprises a respective authentication application.

14. The system according to claim 13, wherein the communication between the gateway and the application server is encrypted.

15. The system according to claim 13, wherein the authentication application associated with the application server further authenticates end user(s).

16. The system according to claim 2, wherein peripheral device(s) is/are remotely controlled or configured through the application server and gateway.

17. The system according to claim 1, wherein the application server transmits data, message(s) or event report(s) to intended end user(s).

18. The system according to claim 17, wherein the data, message(s) or event report(s) is/are transmitted as corresponding SMS(s) or e-mail(s).

19. The system according to claim 3, wherein signal(s) represent digital video stream(s) or picture(s).

20. The system according to claim 19, wherein the application server securely forwards to authorized end user(s), on demand, selected digital video stream(s) and pictures originating from one or more cameras.

21. The system according to claim 20, wherein each camera is assigned a unique code to be used by authorized end user(s) requesting selected pictures or video streams originating from said camera.

22. The system according to claim 1, wherein the communication between the gateway and the application server is monitored by both sides.

23. The system according to claim 22, wherein monitoring occurs periodically.

24. The system according to claim 1, further comprising:
a router functionally coupled to the gateway and to camera(s) for facilitating real-time transfer of picture(s) and video stream(s) to an authorized web user.

25. The system according to claim 24, wherein the router is adapted to receive command(s) from the application server to enable real-time transfer of picture(s) and video stream(s) from the camera(s) to an authorized web user through said router and through the application server.

26. The system according to claim 24, wherein the router is adapted to receive command(s) from the gateway to enable real-time transfer of picture(s) and video stream(s) to an authorized web user through said router and through the application server.

27. The system according to claim 24, wherein the router is adapted to block access to camera(s) after termination of a web video viewing session.

28. A method of remote secure management of applications, comprising: initiating a communication session with an application server enabled to be a single junction for secure data transfer between a gateway and end user(s).

29. The method according to claim 28, wherein the gateway is functionally coupled to one or more peripheral devices, each of which may be configured or controlled by said gateway.

30. The method of claim 28, further comprising connecting a web server to said application server, to enable authorized web end user(s) to remotely access peripheral device(s) through said application server.

31. The method of claim 28, further comprising providing a proxy server to mediate between the application server and third party application(s).

32. The method of claim 28, further comprising exchanging authenticating data between the application server and the gateway, and between end user(s) and said application server.

33. The method of claim 28 further comprising exchanging encrypting data between the application server and the gateway.
